(19) United States
(12) Patent Application Publication
(10) Pub. No.: US 2025/0265889 A1
(43) Pub. Date: Aug. 21, 2025

(54) COMMODITY SALES SYSTEM, CONTROL METHOD FOR COMMODITY SALES SYSTEM, TICKET ISSUING DEVICE, AND LOCKER DEVICE

(71) Applicant: GLORY LTD., Himeji-shi (JP)

(72) Inventor: Tadashi INOKUCHI, Himeji-shi (JP)

(73) Assignee: GLORY LTD., Himeji-shi (JP)

(21) Appl. No.: 19/053,503

(22) Filed: Feb. 14, 2025

(30) Foreign Application Priority Data
Feb. 16, 2024 (JP) 2024-022442

(51) Int. Cl. G07F 7/12

(52) U.S. Cl. CPC G07F 7/12

(57) ABSTRACT

A commodity sales system includes a locker device, a ticket issuing device, and a controller. The ticket issuing device includes a ticket issuer and an interface configured to accept an input from a user. The locker device includes a locking unit provided for each locker box, and a reader configured to read information. The controller accepts designation of a commodity to be purchased, via the interface, causes the ticket issuer to issue a purchase ticket holding unlocking information for unlocking the locker box in which the designated commodity is stored, in a form that can be read by the reader, and unlocks the locker box based on the unlocking information read from the purchase ticket by the reader.

### CROSS-REFERENCE TO RELATED APPLICATION

This application claims priority under 35 U.S.C. Section 119 of Japanese Patent Application No. 2024-022442 filed Feb. 16, 2024, entitled “COMMODITY SALES SYSTEM, CONTROL METHOD FOR COMMODITY SALES SYSTEM, TICKET ISSUING DEVICE, AND LOCKER DEVICE”. The disclosure of the above application is incorporated herein by reference.

### BACKGROUND OF THE INVENTION

### Field of the Invention

The present invention relates to a commodity sales system for selling a commodity using a locker device, a control method for the commodity sales system, a ticket issuing device, and a locker device.

### Description of Related Art

To date, a non-face-to-face sales format can be used in stores. In this sales format, for example, a locker device in which commodities are stored in a plurality of locker boxes, respectively, can be used. Each locker box can be locked. When a user performs a payment process for a purchase price, the locker box is unlocked.

In the configuration described in Japanese Laid-Open Patent Publication No. 2018-163393, after the user deposits money, when the user selects a commodity to be purchased, the door of the locker box is set to be in an open state. Accordingly, the user can take out the commodity to be purchased from the locker box.

However, in the configuration described in Japanese Laid-Open Patent Publication No. 2018-163393, since the door is opened each time money is deposited and a commodity is selected, the user needs to take out the commodity each time. Such an operation is very troublesome when purchasing a plurality of commodities at once.

### SUMMARY OF THE INVENTION

A first aspect of the present invention is directed to a commodity sales system. The commodity sales system according to this aspect includes: a locker device in which commodities are stored in a plurality of locker boxes, respectively; a ticket issuing device having a function of settling purchase prices of the commodities; and a controller. The ticket issuing device includes a ticket issuer, and an interface configured to accept an input from a user. The locker device includes a locking unit provided for each of the locker boxes, and a reader configured to read information. The controller accepts designation of a commodity to be purchased, via the interface, causes the ticket issuer to issue a purchase ticket holding unlocking information for unlocking the locker box in which the designated commodity is stored, in a form that can be read by the reader, and unlocks the locker box based on the unlocking information read from the purchase ticket by the reader.

With the commodity sales system according to this aspect, when purchasing a plurality of commodities at once, the user can acquire the purchase ticket for unlocking each of a plurality of locker boxes in which these commodities are stored, from the ticket issuing device, can unlock these locker boxes by causing the reader of the locker device to read the acquired purchase ticket, and can take out the commodities therefrom. Therefore, even when purchasing a plurality of commodities at once, the operation for purchasing the commodities can be smoothly and reliably performed.

A second aspect of the present invention is directed to a control method for a commodity sales system including a locker device in which commodities are stored in a plurality of locker boxes, respectively, and a ticket issuing device having a function of settling purchase prices of the commodities. The control method according to this aspect includes: accepting designation of a commodity to be purchased, via an interface; causing the ticket issuing device to issue a purchase ticket holding unlocking information for unlocking the locker box in which the designated commodity is stored, in a readable form; and unlocking the locker box based on the unlocking information read from the purchase ticket.

With the control method according to this aspect, the same effects as those of the above first aspect are achieved.

A third aspect of the present invention is directed to a ticket issuing device having a function of settling purchase prices of commodities stored in a plurality of locker boxes of a locker device, respectively. The ticket issuing device according to this aspect includes: a ticket issuer; an interface configured to accept an input from a user; and a controller. The controller accepts designation of a commodity to be purchased, via the interface, and causes the ticket issuer to issue a purchase ticket holding unlocking information for unlocking the locker box in which the designated commodity is stored, in a form that can be read by a reader of the locker device.

With the ticket issuing device according to this aspect, the same effects as those of the above first aspect are achieved.

A fourth aspect of the present invention is directed to a locker device constituting a commodity sales system together with a ticket issuing device configured to issue a purchase ticket holding unlocking information for unlocking a locker box in which a commodity to be purchased that is designated by a user via an interface is stored, in a readable form, in response to settlement of a purchase price of the commodity. The locker device according to this aspect includes: a plurality of locker boxes for storing commodities, respectively; a locking unit provided for each of the locker boxes; a reader configured to read information; and a controller configured to unlock the locker box based on the unlocking information read from the purchase ticket by the reader.

With the locker device according to this aspect, the same effects as those of the above first aspect are achieved.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 is a diagram showing a configuration of a commodity sales system according to an embodiment;

FIG. 2 is a front view showing a configuration of a main body of a locker device according to the embodiment;

FIG. 3A is a front view showing a configuration of a locker box in a state where a door is opened, according to the embodiment;

FIG. 3B is a see-through view schematically showing a configuration when the locker box in a state where the door is closed is seen through from the left side;

FIG. 4 is a front view showing a configuration of a ticket issuing device according to the embodiment;

FIG. 5 is a diagram showing configurations of circuitries of the locker device and the ticket issuing device according to the embodiment;

FIG. 6A to FIG. 6C are diagrams respectively showing configurations of various kinds of management information stored in a memory of the ticket issuing device according to the embodiment;

FIG. 7 is a diagram showing a configuration of box management information stored in a memory of the locker device according to the embodiment;

FIG. 8A and FIG. 8B are diagrams respectively showing configurations of an acceptance screen and a box selection screen displayed on an interface of the ticket issuing device when a commodity is to be purchased, according to the embodiment;

FIG. 9A and FIG. 9B are diagrams respectively showing configurations of a settlement screen and a settlement completion screen according to the embodiment;

FIG. 10 is a flowchart showing processing of the ticket issuing device when a commodity is to be purchased, according to the embodiment;

FIG. 11A is a diagram showing a configuration of a purchase ticket according to the embodiment;

FIG. 11B is a diagram showing a configuration of unlocking information held in a code figure on the purchase ticket according to the embodiment;

FIG. 12A and FIG. 12B are diagrams respectively showing configurations of an acceptance screen and an unlocking notification screen displayed on a display input module of the locker device when a commodity is to be taken out, according to the embodiment;

FIG. 13 is a diagram showing a configuration of an error notification screen displayed on the display input module of the locker device when a commodity is to be taken out, according to the embodiment;

FIG. 14 is a flowchart showing processing of the locker device when a commodity is to be taken out, according to the embodiment;

FIG. 15 is a flowchart showing processing performed by the locker device when the locker box is to be replenished with a commodity, according to the embodiment;

FIG. 16A is a diagram showing a configuration of a mode selection screen displayed on the display input module of the locker device when the locker box is to be replenished with a commodity, according to the embodiment;

FIG. 16B is a diagram showing a replenishment acceptance screen displayed when a full open mode is selected on the mode selection screen, according to the embodiment;

FIG. 17A is a diagram showing a configuration of the replenishment acceptance screen displayed when an individual open mode is selected on the mode selection screen, according to the embodiment;

FIG. 17B is a diagram showing a configuration of the replenishment acceptance screen displayed when an empty open mode is selected on the mode selection screen, according to the embodiment;

FIG. 18 is a diagram showing a configuration of the replenishment acceptance screen displayed when a time-expired open mode is selected on the mode selection screen, according to the embodiment; and

FIG. 19 is a flowchart showing processing of issuing a password for commodity replenishment according to a modification.

### DETAILED DESCRIPTION

Hereinafter, an embodiment of the present invention will be described with reference to the drawings.

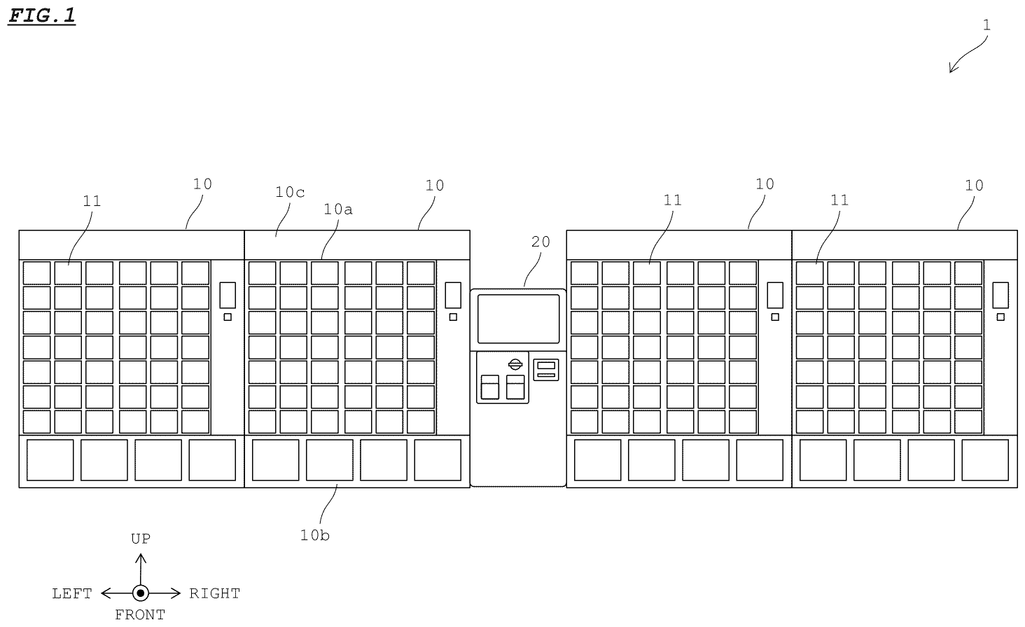

FIG. 1 is a front view showing a configuration of a commodity sales system 1.

The commodity sales system 1 includes a locker device 10 and a ticket issuing device 20. Here, four locker devices 10 are installed in a store. However, the number of locker devices 10 installed in the store is not limited to this number, and it is sufficient that at least one locker device 10 is installed therein. The ticket issuing device 20 is used for settling the purchase prices of commodities stored in each of the four locker devices 10. A plurality of pairs of at least one locker device 10 and a ticket issuing device 20 may be installed in the store.

Each locker device 10 includes a main body 10a, a stand 10b on which the main body 10a is installed, and a base 10c that is placed on the main body 10a. In the main body 10a, a plurality of locker boxes 11 are arranged in a matrix pattern. Here, 42 locker boxes 11 are arranged in each locker device 10. However, the number of locker boxes 11 arranged in one locker device 10 is not limited to this number.

A commodity to be sold is stored in each locker box 11. The commodity to be sold is, for example, eggs. A predetermined number of eggs are packed and stored in each locker box 11. However, the commodity to be sold is not limited to eggs and may be another commodity such as agricultural products.

In the stand 10b, a plurality of doors through which equipment, etc., can be stored are arranged. In the base 10c, circuitries such as a power supply circuit, a power switch, and a control board of the locker device 10 are housed.

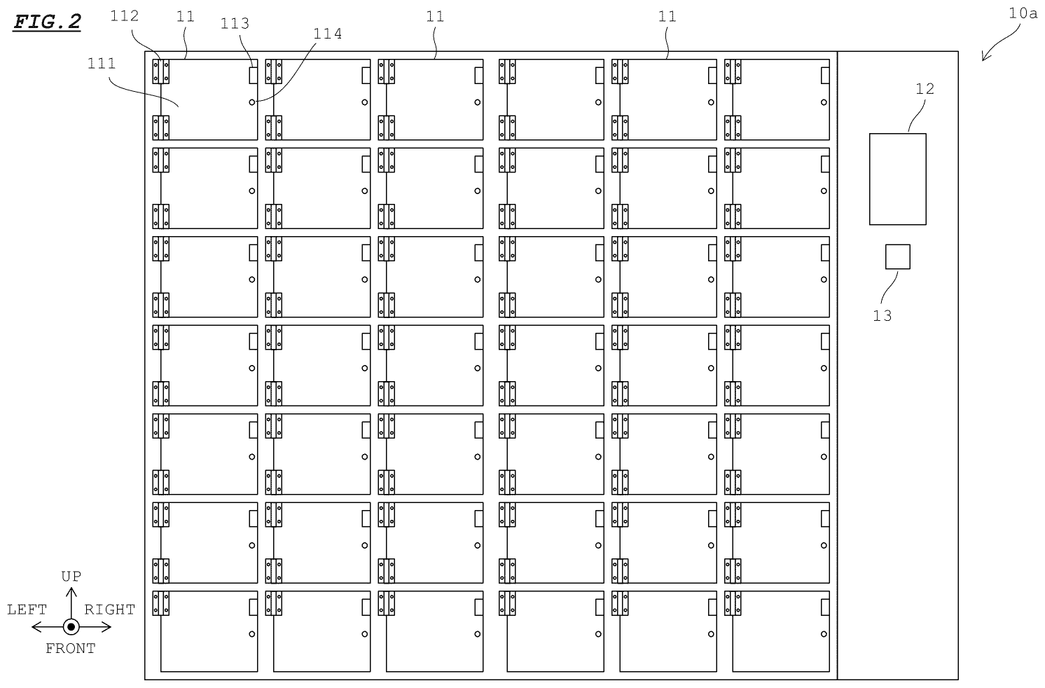

FIG. 2 is a front view showing a configuration of the main body 10a of the locker device 10.

In the main body 10a, a display input module 12 and a reader 13 are placed in addition to the 42 locker boxes 11.

The display input module 12 is composed of a touch panel or the like and is capable of displaying and inputting information. The display input module 12 presents information such as an unlocking procedure to a user, who is a customer, when a locker box 11 for taking out a purchased commodity is to be unlocked. When a purchased commodity is to be taken out, an input to the display input module 12 is invalidated. In addition, the display input module 12 presents information such as an unlocking procedure to a manager when a locker box 11 for commodity replenishment is to be unlocked. In this case, an input to the display input module 12 is validly accepted.

The reader 13 reads unlocking information on a purchase ticket issued by the ticket issuing device 20, as described later. Here, the unlocking information is held as a QR code (registered trademark) on the purchase ticket. The reader 13 is a QR code (registered trademark) reader. However, the form of holding the unlocking information is not limited to this form, and the unlocking information may be held on the purchase ticket in another form such as a barcode, for example.

Each locker box 11 includes a transparent door 111. The door 111 is installed in the locker box 11 by means of two hinges 112 so as to be able to be opened and closed. The door 111 includes a knob 114 that is grasped when opening and closing the door 111 and a locked part 113 for locking the door 111 into a closed state. The knob 114 may be translucent.

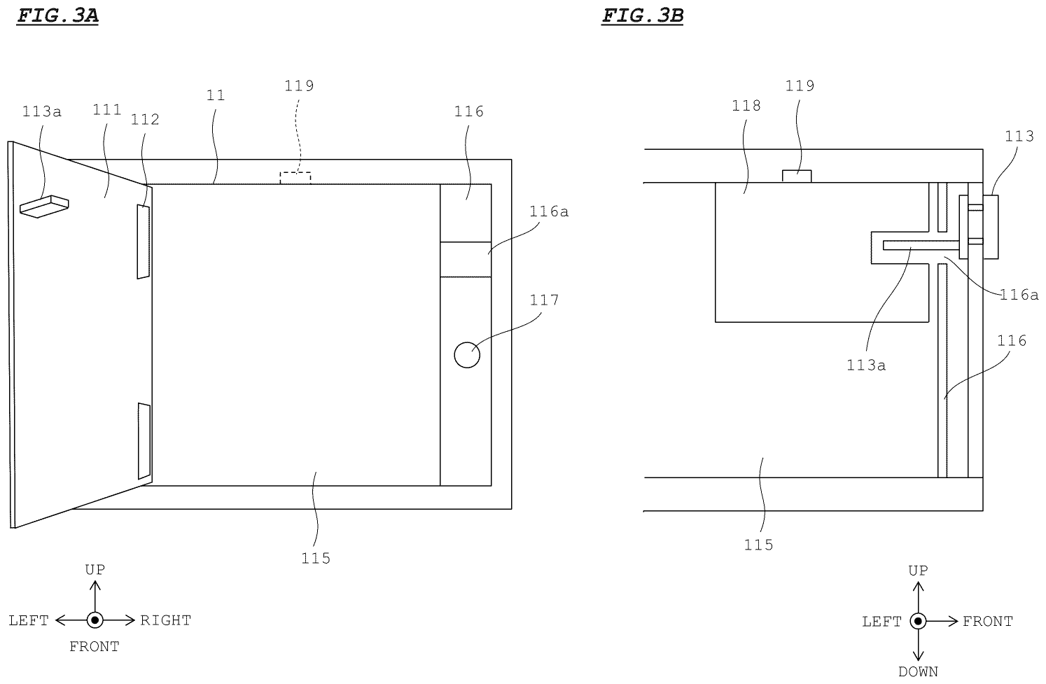

FIG. 3A is a front view showing a configuration of the locker box 11 in a state where the door 111 is opened. FIG. 3B is a see-through view schematically showing a configuration when the locker box 11 in a state where the door 111 is closed is seen through from the left side.

As shown in FIG. 3A, when the door 111 is opened, a storage part 115 (storage space) for storing a commodity is opened. A flat plate 116 is placed at the right end of the storage part 115 so as to extend vertically. The flat plate 116 is provided with a lighting part 117 at a position corresponding to the knob 114 on the door 111 side. The lighting part 117 is composed of, for example, an LED. The lighting part 117 may be composed of a lamp other than an LED. When the lighting part 117 lights up in a state where the door 111 is closed, the knob 114 on the front of the door 111 and an area surrounding the knob 114 emit light in the color of the lighting part 117. The color of the light emitted by the lighting part 117 is set to a color that is easily visible to the user, such as green or blue.

The flat plate 116 is provided with a gap 116a. As shown in FIG. 3B, a lock mechanism 118 is placed at the back of the gap 116a. Meanwhile, the locked part 113 on the door 111 side is provided with a claw part 113a that protrudes from the back side of the door 111. When the door 111 is closed, the claw part 113a fits into the lock mechanism 118. When the claw part 113a fits into the lock mechanism 118, the claw part 113a is automatically locked by the lock mechanism 118. Accordingly, the door 111 is locked into a closed state.

An illumination part 119 for illuminating the interior of the storage part 115 is placed on the inner surface on the upper side of the storage part 115. The illumination part 119 is composed of, for example, an LED. The illumination part 119 may be composed of a lamp other than an LED. When the door 111 is unlocked, the illumination part 119 is lit and a commodity stored in the storage part 115 is illuminated by the light from the illumination part 119. In addition, a part of the light from the illumination part 119 is guided from the transparent door 111 to the outside. Accordingly, the user can smoothly take out the commodity from the unlocked locker box 11.

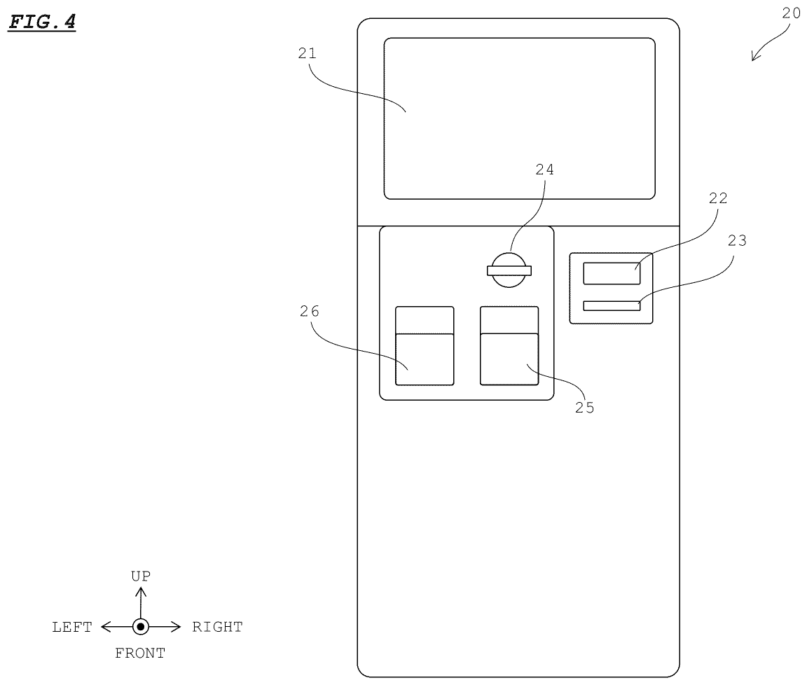

FIG. 4 is a front view showing a configuration of the ticket issuing device 20.

The ticket issuing device 20 includes an interface 21, a banknote inlet 22, a banknote outlet 23, a coin inlet 24, a coin outlet 25, and a ticket issuing port 26.

The interface 21 presents predetermined information to the user and accepts an input from the user in response to the presented information. The interface 21 is composed of, for example, a touch panel. However, the configuration of the interface 21 is not limited thereto.

The banknote inlet 22 is used for depositing banknotes when settling the price of a commodity. The banknote outlet 23 is used for dispensing change banknotes. In addition, if a banknote deposited from the banknote inlet 22 is an unfit note, the banknote outlet 23 is used for returning the banknote. The coin inlet 24 is used for depositing coins when settling the price of a commodity. The coin outlet 25 is used for dispensing change coins. In addition, if a coin deposited from the coin inlet 24 is a deformed coin, the coin outlet 25 is used for returning the coin.

The ticket issuing port 26 is used for issuing a purchase ticket. When settlement for a commodity to be purchased is completed, a purchase ticket for unlocking the locker box 11 in which this commodity is stored is issued from the ticket issuing port 26. As described above, unlocking information for unlocking the locker box 11 is held as a QR code (registered trademark) on the purchase ticket. That is, the QR code (registered trademark) holding the unlocking information is printed on the surface of the purchase ticket. Other information such as the commodity name, the price, and the date and time of settlement may be printed on the surface of the purchase ticket.

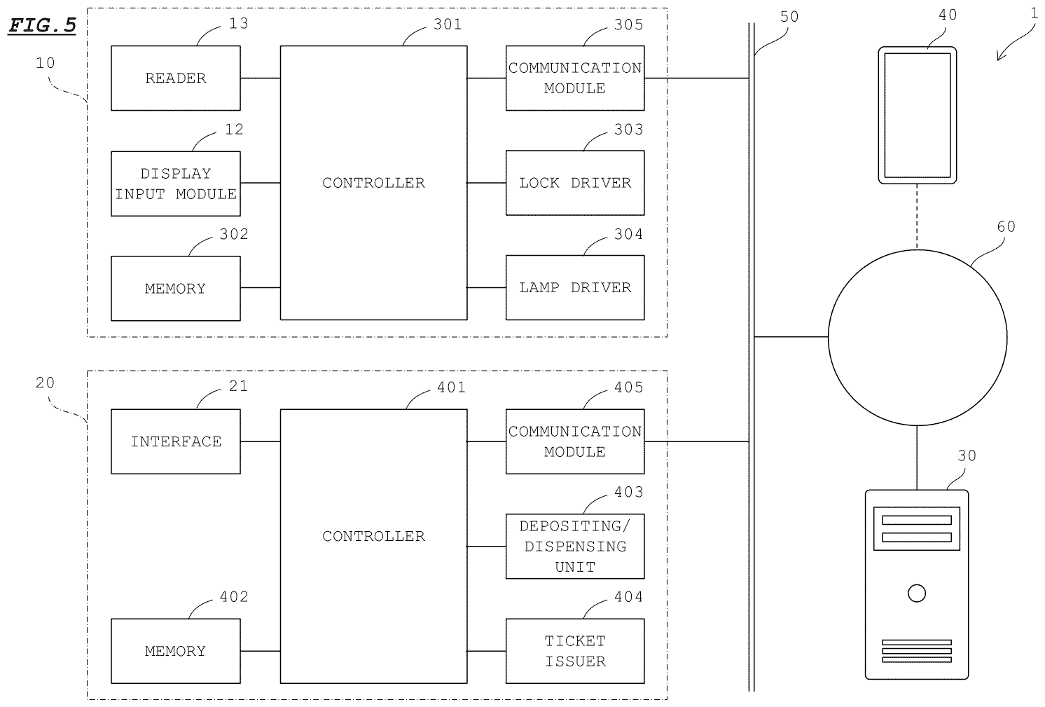

FIG. 5 is a diagram showing configurations of circuitries of the locker device 10 and the ticket issuing device 20.

FIG. 5 also shows a server device 30 and a mobile terminal 40. The server device 30 and the mobile terminal 40 are used when the locker device 10 is to be replenished with a commodity, as described later. That is, the server device 30 and the mobile terminal 40 constitute a system that issues other unlocking information for unlocking a locker box 11 when the locker device 10 is to be replenished with a commodity.

FIG. 5 shows the configuration of the circuitry of only one locker device 10, and the four locker devices 10 shown in FIG. 1 have the same circuit configuration. The four locker devices 10 are all capable of communicating with the ticket issuing device 20 via a LAN (Local Area Network) 50 and also capable of communicating with the server device 30 via the LAN 50 and an external communication network 60.

In addition to the display input module 12 and the reader 13 shown in FIG. 2, the locker device 10 includes a controller 301, a memory 302, a lock driver 303, a lamp driver 304, and a communication module 305.

The controller 301 includes an arithmetic processing circuit such as a CPU (Central Processing Unit) and controls each component according to a program stored in the memory 302. The memory 302 includes memories such as a ROM (read only memory) and a RAM (random access memory) and stores the above program therein. In addition, the memory 302 is used as a work area when the controller 301 executes the above program.

The lock driver 303 individually drives the above-described lock mechanism 118 which is placed in each locker box 11. As described above, the lock mechanism 118 automatically locks the claw part 113a when the door 111 is closed. The lock driver 303 includes a driver that drives the lock mechanism 118 so as to unlock the claw part 113a under control from the controller 301, for each locker box 11 (for each lock mechanism 118).

The lamp driver 304 drives the lighting part 117 and the illumination part 119 described above, which are placed in each locker box 11. The lamp driver 304 includes a plurality of drivers provided for the locker boxes 11, respectively. The communication module 305 communicates with the ticket issuing device 20 and the server device 30 under control from the controller 301.

In addition to the interface 21 shown in FIG. 4, the ticket issuing device 20 includes a controller 401, a memory 402, a depositing/dispensing unit 403, a ticket issuer 404, and a communication module 405.

The controller 401 includes an arithmetic processing circuit such as a CPU and controls each component according to a program stored in the memory 402. The memory 402 includes memories such as a ROM and a RAM and stores the above program therein. In addition, the memory 402 is used as a work area when the controller 401 executes the above program.

The depositing/dispensing unit 403 performs depositing and dispensing of banknotes and coins with respect to the banknote inlet 22, the banknote outlet 23, the coin inlet 24, and the coin inlet 24. The depositing/dispensing unit 403 includes a transport mechanism that transports banknotes and coins along a transport path, a recognition unit that recognizes the denominations of banknotes and coins on the transport path, and a plurality of banknote storage parts and a plurality of coin storage parts that store deposited banknotes and coins by denomination. The transport path for banknotes is connected to the banknote inlet 22 and the banknote outlet 23 in FIG. 4 and the plurality of banknote storage parts. The transport path for coins is connected to the coin inlet 24 and the coin outlet 25 in FIG. 4 and the plurality of coin storage parts.

The ticket issuer 404 issues the above-described purchase ticket. The ticket issuer 404 includes a printing unit that prints the QR code (registered trademark) holding the unlocking information, etc., on a roll of paper, and a cutting unit that cuts the roll of paper on which printing has been performed by the printing unit into a predetermined length to generate the purchase ticket.

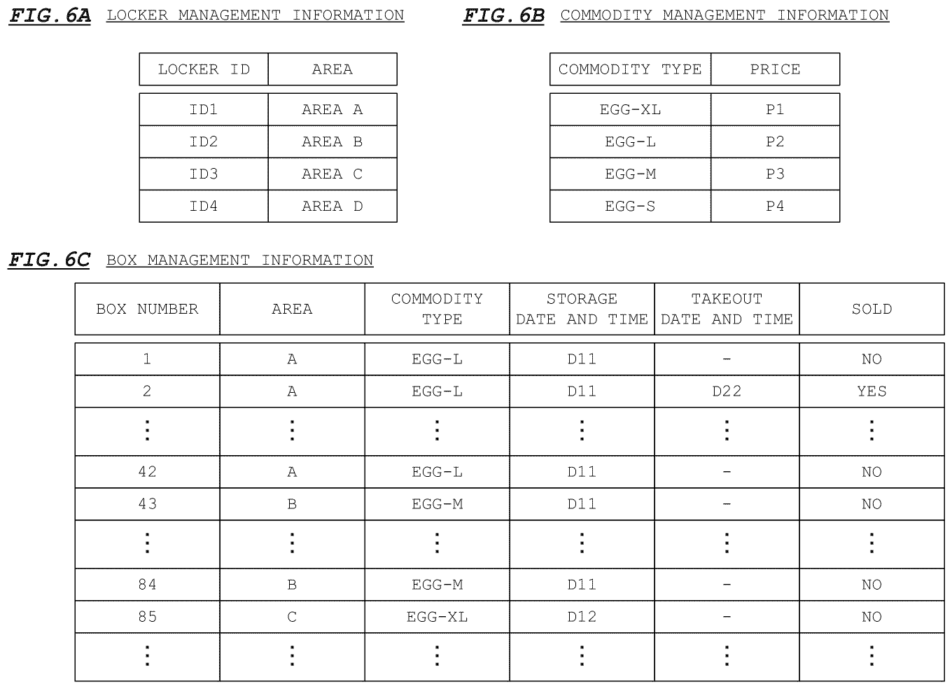

FIGS. 6A to 6C are diagrams respectively showing configurations of various kinds of management information stored in the memory 402 of the ticket issuing device 20.

FIG. 6A shows a configuration of locker management information for managing the locker devices 10 installed in the store. The locker management information is configured by associating a locker ID that is identification information of each locker device 10 and area information indicating an area where each locker device 10 is installed.

The locker ID is, for example, a product code assigned to each locker device 10. The area information is an area code assigned to the installation area of each locker device 10, in a layout image described later. Here, four installation areas are set on the layout image and area codes that are areas A to D are assigned to these four installation areas, respectively. The setting of the installation areas on the layout image and the association of each installation area with the locker ID is performed by a manager of the store or a worker who installs the commodity sales system 1, via a predetermined setting screen prepared in the ticket issuing device 20.

FIG. 6B shows a configuration of commodity management information for managing commodities stored in each locker device 10. The commodity management information is configured by associating each commodity type and the commodity price of each commodity type. Here, four commodity types of eggs from XL size to S size are set. The setting of the commodity types and the prices is performed by the manager of the store via a predetermined setting screen prepared in the ticket issuing device 20.

FIG. 6C shows box management information for managing the status of the commodity in each locker box 11.

The box management information is configured by associating a box number, area information, a commodity type, storage date and time, takeout date and time, and sold information.

The “box number” is a number assigned to each locker box 11. Here, a series of numbers is set for all locker boxes 11 provided in the four locker devices 10.

That is, numbers 1 to 42 are assigned to the 42 locker boxes 11 of the locker device 10 installed in the area A, respectively. Numbers 43 to 84 are assigned to the 42 locker boxes 11 of the locker device 10 installed in the area B, respectively, and numbers 85 to 126 are assigned to the 42 locker boxes 11 of the locker device 10 installed in the area C, respectively. Numbers 127 to 168 are assigned to the 42 locker boxes 11 of the locker device 10 installed in the area D, respectively.

In each locker device 10, the first number is assigned to the locker box 11 in the upper left corner, and the last number is assigned to the locker box 11 in the lower right corner. The number increases in increments of 1 from the locker box 11 at the uppermost stage toward the locker box 11 at the lowermost stage. After the number is assigned to the locker box 11 at the lowermost stage, the next number is assigned to the locker box 11 at the uppermost stage in the column to the right, and the numbers are assigned to the column. In this manner, consecutive numbers are assigned from the locker box 11 in the upper left corner to the locker box 11 in the lower right corner.

The “area information” is the installation area (area code) of the locker device 10 to which the locker box 11 of each box number belongs. As described above, the relationship between each area and each box number is defined in advance. In accordance with this relationship, an area is associated with each box number.

The “commodity type” is the type of a commodity stored in the locker box 11 of each box number. Any of the commodity types set in the commodity management information in FIG. 6B is registered therein. In the example in FIG. 6C, the commodity type is different for each area. The method for setting a commodity type is not limited thereto, and, for example, the same commodity type may be set for all areas, or the same commodity type may be set for two areas. The setting of a commodity type for each area is performed by the manager of the store via a predetermined setting screen prepared in the ticket issuing device 20.

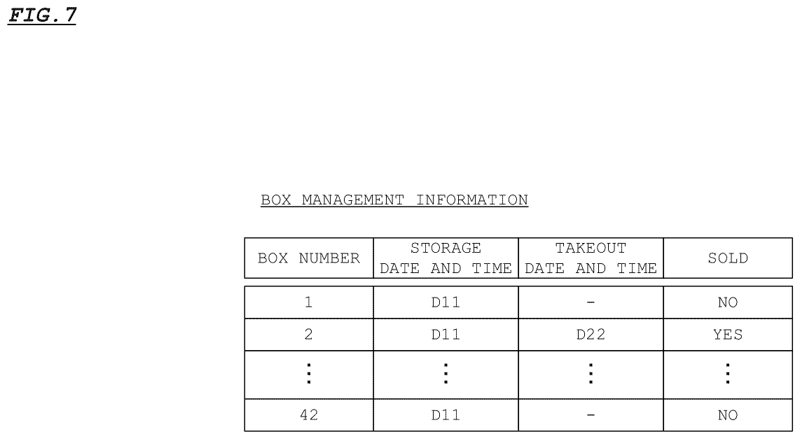

The “storage date and time” is the date and time when a commodity was stored in the locker box 11 of each box number. When the locker box 11 is replenished with a commodity by a replenishment mode described later, a notification of this is transmitted from the corresponding locker device 10 to the ticket issuing device 20. In response to this, the ticket issuing device 20 (controller 401) registers the date and time when this notification was received, in the cell of “storage date and time” for the corresponding locker box 11. This notification may include the storage date and time (see FIG. 7) of the commodity set on the locker device 10 side. In this case, the ticket issuing device 20 (controller 401) registers the storage date and time included in this notification, in the cell of “storage date and time” for the corresponding locker box 11.

The “takeout date and time” is the date and time when the commodity was taken out from the locker box 11 of each box number. When the commodity is taken out from the locker box 11 by a takeout mode described later, a notification of this is transmitted from the corresponding locker device 10 to the ticket issuing device 20. In response to this, the ticket issuing device 20 (controller 401) registers the date and time when this notification was received, in the cell of “takeout date and time” for the corresponding locker box 11. This notification may include the takeout date and time (see FIG. 7) of the commodity set on the locker device 10 side. In this case, the ticket issuing device 20 (controller 401) registers the takeout date and time included in this notification, in the cell of “takeout date and time” for the corresponding locker box 11.

The “sold” is information indicating whether or not the commodity in the locker box 11 of each box number has been sold, that is, information indicating whether or not the locker box 11 is empty. When a commodity is stored in the locker box 11 and the date and time is registered in the cell of “storage date and time”, information indicating that the commodity has not been sold (here, information of “NO”) is registered in the cell of “sold” for this locker box 11. When the commodity is taken out from the locker box 11 and the date and time is registered in the cell of “takeout date and time”, information indicating that the commodity has been sold (here, information of “YES”) is registered in the cell of “sold” for this locker box 11.

FIG. 7 is a diagram showing a configuration of box management information stored in the memory 302 of the locker device 10.

The box management information managed on the locker device 10 side is the box management information in FIG. 6C from which the “area” and “commodity type” items are omitted. The “box number” is the number for each of the 42 locker boxes 11 of the locker device 10. Here, box numbers 1 to 42 are assigned to each locker device 10. That is, in each locker device 10, box numbers 1 to 42 are assigned from the locker box 11 in the upper left corner to the locker box 11 in the lower right corner. Numbers 1 to 7 are assigned to the column in the up-down direction including the locker box 11 in the upper left corner, and numbers 8 to 14 are assigned to the column to the right of this column. In this manner, numbers are assigned up to the rightmost column using the same rule.

The “storage date and time”, “takeout date and time”, and “sold” items are the same as the corresponding items of the box management information in FIG. 6C. When a commodity is stored in the locker box 11 corresponding to a certain box number, the controller 301 of the locker device 10 registers the date and time when this commodity is stored, in the cell of “storage date and time” for this box number. In addition, when a commodity is taken out from the locker box 11 corresponding to a certain box number, the controller 301 of the locker device 10 registers the date and time when this commodity is taken out, in the cell of “takeout date and time” for this box number.

When a commodity is stored or taken out for a certain box number, the controller 301 of the locker device 10 transmits a notification of this together with this box number and the locker ID of the locker device 10 to the ticket issuing device 20. The controller 401 of the ticket issuing device 20 identifies the area of this locker device 10 using the locker management information in FIG. 6A from the received locker ID. Then, the controller 401 converts the received box number into a numbering system corresponding to the identified area (a sequential numbering system for the four locker devices 10), and registers the date and time when these notifications were received, in the cells of “storage date and time” and “takeout date and time” associated with the converted box number. For example, when a notification indicating a commodity for a box number “33” has been taken out is received from the locker device 10 in the area B, the controller 401 of the ticket issuing device 20 registers the date and time when this notification was received, in the cell of “takeout date and time” associated with a box number “75”.

When a commodity takeout process is executed a plurality of times using the same purchase ticket as described later, the date and time of takeout in the first takeout process is registered in the cell of “takeout date and time” item. The cell of “takeout date and time” is blanked when a process of replenishing the locker box 11 of the corresponding box number with a new commodity is performed. At this time, the cell of “storage date and time” for this box number is updated with the storage date and time of the new commodity, and the cell of “sold” is updated with information of “NO”.

### <Purchase Mode>

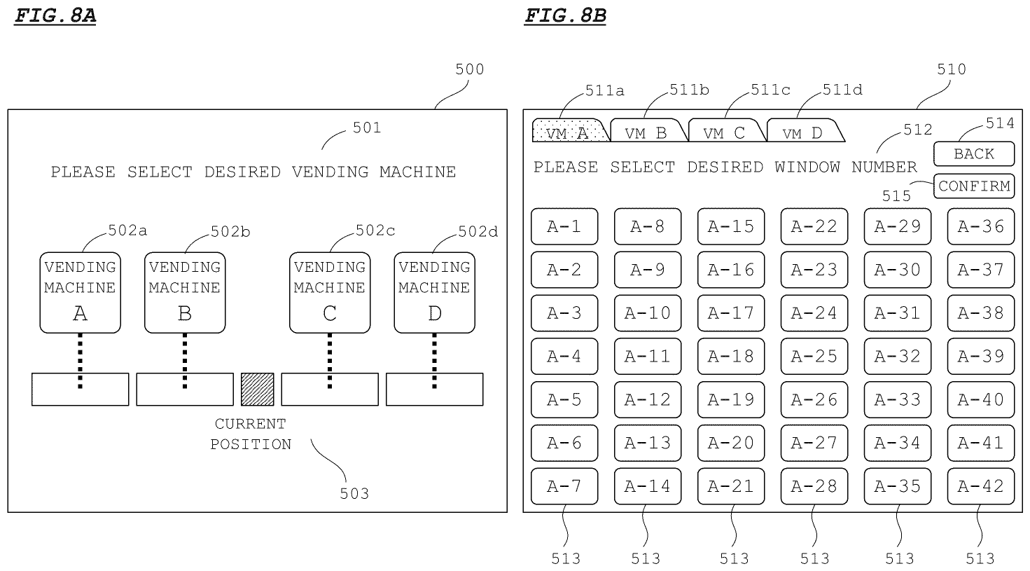

FIG. 8A is a diagram showing a configuration of an acceptance screen 500 displayed on the interface 21 of the ticket issuing device 20 when a commodity is to be purchased.

Prior to purchasing a commodity, the user, who is a customer, refers to the commodity stored in each locker box 11 of the four locker devices 10, through the transparent door 111, determines a commodity to be purchased by the user, and grasps the position of this commodity. Then, the user moves to the ticket issuing device 20 in order to purchase the commodity and operates the acceptance screen 500 displayed on the interface 21 of the ticket issuing device 20.

The acceptance screen 500 includes a message 501 that urges the user to select a locker device 10 (vending machine), selection buttons 502a to 502d for selecting a locker device 10 (vending machine), and a layout image 503 showing the layout of the four locker devices 10 (vending machines). The selection buttons 502a to 502d are labeled with the area names (A to D) indicating the installation areas of the four locker devices 10 shown in the layout image 503, and the selection buttons 502a to 502d are also associated with figures of the respective locker devices 10 on the layout image 503 by dotted lines, respectively.

The user can grasp the locker device 10 holding the commodity to be purchased by the user, from the selection buttons 502a to 502d and the layout image 503. Accordingly, the user operates the selection button corresponding to the locker device 10 holding the commodity to be purchased by the user, among the selection buttons 502a to 502d.

FIG. 8B is a diagram showing a configuration of a box selection screen 510 displayed on the interface 21 when the selection button 502a is operated on the acceptance screen 500 in FIG. 8A.

The box selection screen 510 includes tab images 511a to 511d indicating which locker device 10 (vending machine) is being selected, a message 512 that urges the user to select a locker box 11, 42 selection buttons 513 for selecting a locker box 11, a button 514 for returning the screen to the acceptance screen 500, and a confirmation button 515 for confirming a selection.

The 42 selection buttons 513 are arranged in the same layout as the 42 locker boxes 11 in the locker device 10. Each selection button 513 is labeled with a symbol indicating the area of this locker device and the box number of the corresponding locker box 11. For example, A-1 on the selection button 513 in the upper left corner indicates that the locker box 11 of a box number “1” in the locker device 10 installed in the area A corresponds to this selection button 513. Here, the selection button 513 corresponding to a box number for which “YES” is in the cell of “sold” in FIG. 6C is grayed out and cannot be selected.

The user operates the selection button 513 corresponding to the locker box 11 holding the commodity to be purchased by the user among the 42 selection buttons 513. When there are a plurality of commodities to be purchased, the user can operate a plurality of selection buttons 513 corresponding to a plurality of locker boxes 11 in which these commodities are stored, respectively. When the user operates the desired selection button 513, that selection button 513 is displayed in a different color from the non-selected selection buttons 513. Accordingly, the user can grasp the selection button 513 selected by the user. When the user operates the selected selection button 513 again, the selection for that selection button 513 is canceled. Accordingly, the color of this selection button 513 is returned to the color in a non-selected state.

After operating the desired selection button 513 as described above, the user operates the confirmation button 515. Accordingly, the selection of the locker box 11 is completed, and a settlement screen for settling the price of the selected commodity is displayed.

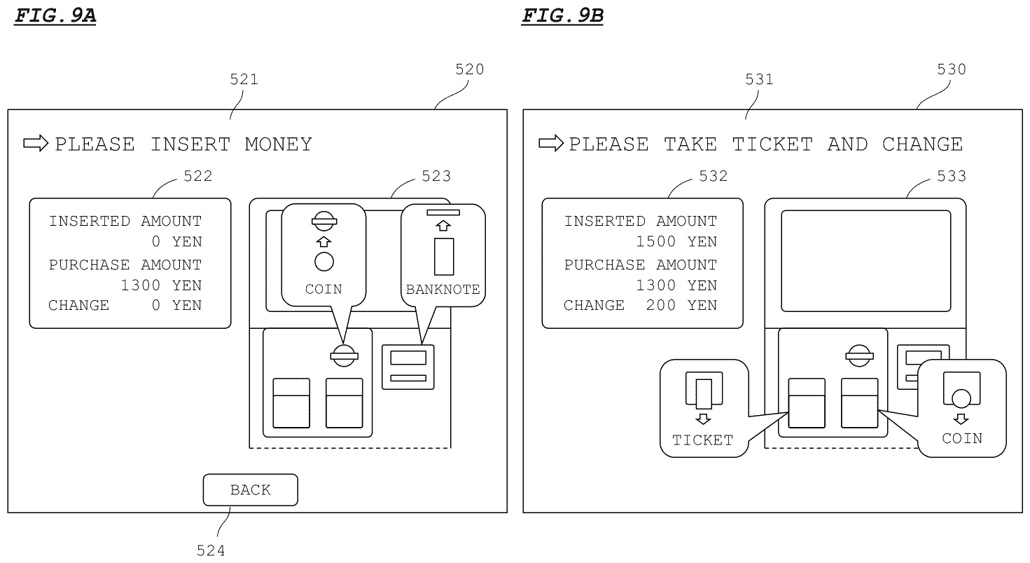

FIG. 9A is a diagram showing a configuration of a settlement screen 520.

The settlement screen 520 includes a message 521 that urges the user to insert money for settlement, a settlement display region 522 indicating a monetary amount for settlement, an image 523 indicating the locations for inserting banknotes and coins in the ticket issuing device 20, and a button 524 for returning the screen to the box selection screen 510.

In the settlement display region 522, an item indicating a total monetary amount (purchase amount) of commodities selected by the user, a total monetary amount (inserted amount) of coins inserted by the user, and a change monetary amount obtained by subtracting the purchase amount from the inserted amount are displayed. The purchase amount is acquired by the controller 401 of the ticket issuing device 20, based on the commodity type (see the box management information in FIG. 6C) associated with each locker box 11 selected by the user and the price (see the commodity management information in FIG. 6B) associated with this commodity type. When the user selects a plurality of locker boxes 11 on the box selection screen 510 in FIG. 8B, the controller 401 calculates the total value of the monetary amounts acquired for the respective selected locker boxes 11, as the purchase amount.

If the total monetary amount of coins inserted by the user becomes equal to or greater than the purchase amount displayed in the settlement display region 522, the controller 401 displays a settlement completion screen 530 in FIG. 9B on the interface 21.

The settlement completion screen 530 includes a message 531 that urges the user to take out a purchase ticket and change, a settlement display region 532 similar to the settlement display region 522 in FIG. 9A, and an image 533 indicating the locations for taking out the purchase ticket and change in the ticket issuing device 20. The user takes out the purchase ticket from the ticket issuing port 26 of the ticket issuing device 20 by referring to the message 531 and the image 533. Accordingly, the operation of the ticket issuing device 20 when a commodity is to be purchased is completed.

When a plurality of locker boxes 11 are selected on the box selection screen 510 in FIG. 8B, a purchase ticket is issued for each selected locker box 11. For example, when five locker boxes 11 are selected on the box selection screen 510, five purchase tickets are issued. On each purchase ticket, a QR code (registered trademark) for unlocking the corresponding locker box 11 is printed.

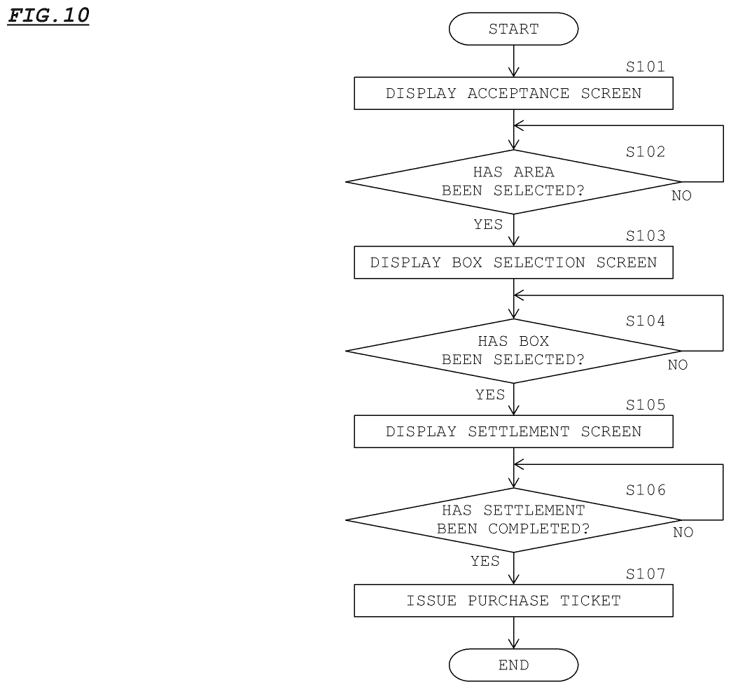

FIG. 10 is a flowchart showing processing of the ticket issuing device 20 when a commodity is to be purchased.

The controller 401 of the ticket issuing device 20 displays the acceptance screen 500 in FIG. 8A on the interface 21 and accepts selection of an area (S101). When the user selects an area via the acceptance screen 500 (S102: YES), the controller 401 displays the box selection screen 510 in FIG. 8B on the interface 21 and accepts selection of a locker box 11 (S103).

When the user selects a locker box 11 via the box selection screen 510 (S104: YES), the controller 401 displays the settlement screen 520 in FIG. 9A on the interface 21 and settles the purchase price (S105). When the user completes the settlement of the purchase price via the box selection screen 510 (S106: YES), the controller 401 displays the settlement completion screen 530 in FIG. 9 on the interface 21 and issues a purchase ticket (S107).

In the case where the ticket issuing device 20 includes a speaker, when displaying the screens in FIG. 9B and FIGS. 10A and 10B on the interface 21, the controller 401 may cause the speaker to output message sounds having the same contents as the messages 512, 521, and 531.

### <Configuration of Purchase Ticket>

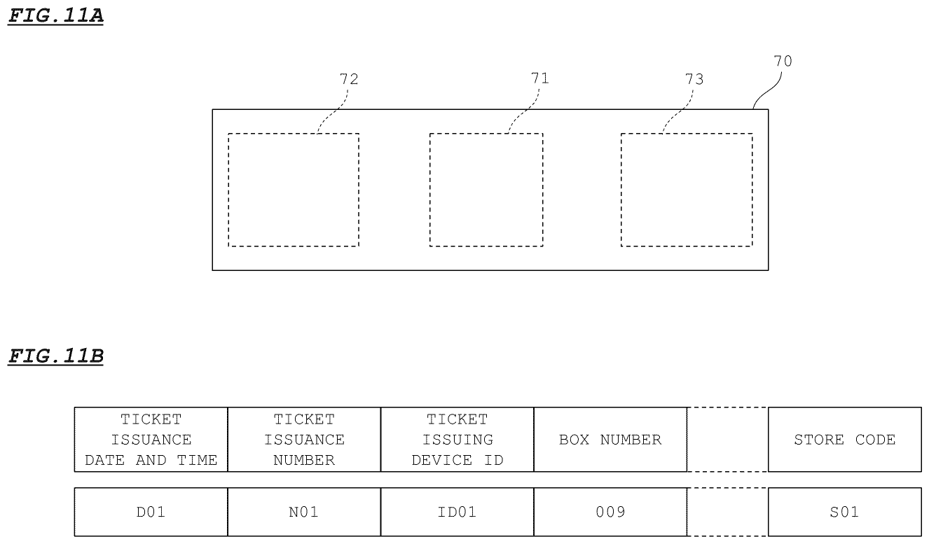

FIG. 11A is a diagram showing a configuration of a purchase ticket 70.

The purchase ticket 70 has a code FIG. 71 displayed at the center thereof. As described above, the code FIG. 71 is a figure of a QR code (registered trademark). In a region 72, the installation area (areas A to D) of the locker device 10 holding a purchased commodity, the box number of the locker box 11 in which the commodity is stored, the commodity type of the commodity stored in the locker box 11, etc., are displayed. In a region 73, the name of the store where the commodity is purchased, the purchase date and time (ticket issuance date and time), a ticket issuance number, etc., are displayed. In order for the purchase ticket 70 to serve as a receipt, the purchase amount may also be displayed in the region 73 or the like.

FIG. 11B is a diagram showing a configuration of unlocking information held in the code FIG. 71.

The unlocking information includes the ticket issuance date and time, the ticket issuance number, a ticket issuing device ID, the box number, and a store code. The “ticket issuance date and time” is the date and time when the purchase ticket 70 was issued. The “ticket issuance number” is a number that is incremented by one each time the ticket issuing device 20 issues a ticket from the time of start of ticket issuance. The “ticket issuing device ID” is identification information (e.g., product code) of the ticket issuing device 20. The “box number” is the box number of the locker box 11 in which the commodity to be purchased is stored. The “box number” has any number from 1 to 168. The “store code” is identification information of the store where the ticket issuing device 20 is installed. The store code is set by the manager of the store via a predetermined setting screen.

### <Takeout Mode>

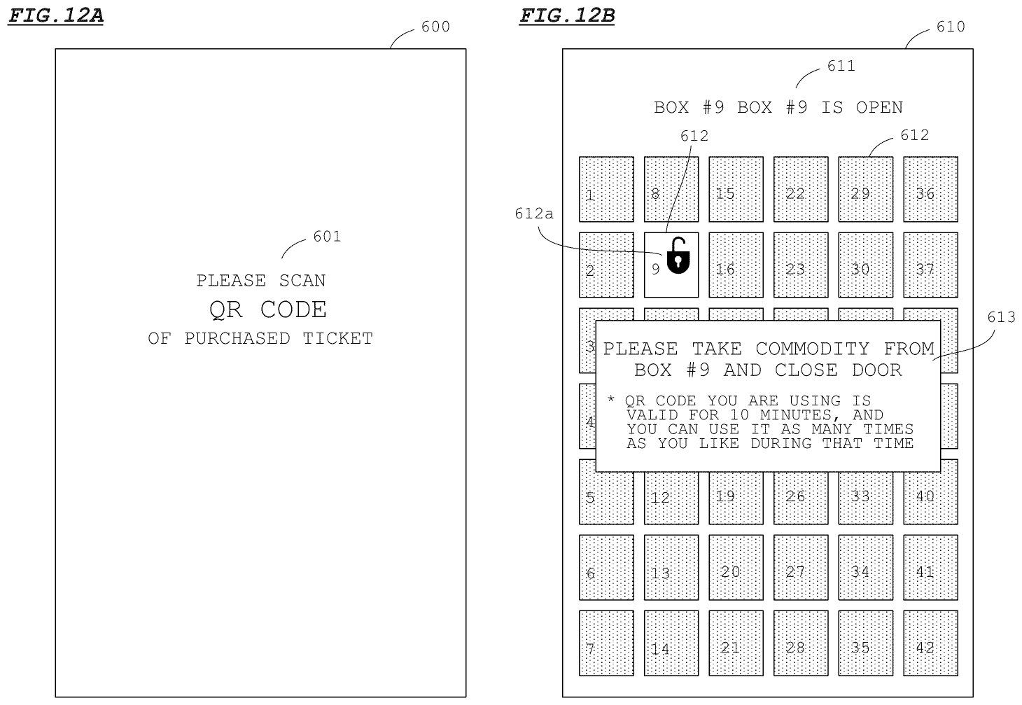

FIG. 12A is a diagram showing a configuration of an acceptance screen 600 displayed on the display input module 12 of the locker device 10 when a commodity is to be taken out.

The acceptance screen 600 includes a message 601 that urges the user to cause the reader 13 to read the code FIG. 71 of the purchase ticket 70 acquired from the ticket issuing device 20. The user holds the code FIG. 71 of the purchase ticket 70 acquired by the user over the reader 13 in response to the message 601, thereby causing the reader 13 to read the code FIG. 71. Accordingly, the unlocking information is acquired from the purchase ticket 70.

If the box number included in the unlocking information matches any of the locker numbers of the 42 locker boxes 11 of the locker device 10, the locker box 11 corresponding to the matched locker number is unlocked. At the same time, the lighting part 117 and the illumination part 119 of the unlocked locker box 11 are lit up. Accordingly, the user grasps the unlocked locker box 11. Furthermore, an unlocking notification screen 610 in FIG. 12B is displayed on the display input module 12.

Here, the locker number included in the unlocking information is a number assigned as a consecutive number to each of a total of 168 locker boxes 11 of the four locker devices 10. The controller 301 of the locker device 10 converts the locker numbers assigned to the 42 locker boxes 11 of the locker device 10 from the area code of the locker device 10 notified from the ticket issuing device 20 into locker numbers that are the above-described consecutive numbers. For example, if the area code of the locker device 10 is the area B, the controller 301 of the locker device 10 converts the box numbers 1 to 42 of the 42 locker boxes 11 of the locker device 10 into box numbers 43 to 84. Then, if the box number in the unlocking information read from the purchase ticket 70 matches any of the converted box numbers, the controller 301 displays the unlocking notification screen 610 shown in FIG. 12B on the display input module 12.

The unlocking notification screen 610 includes a message 611 that notifies that the locker box 11 corresponding to the box number in the unlocking information read from the purchase ticket 70 has been unlocked, box images 612 showing the 42 locker boxes 11 together with the box numbers, and a message image 613 including a message that urges the user to take out the commodity from the unlocked locker box 11 and close the door 111.

The message image 613 includes a message that notifies that the code FIG. 71 of the purchase ticket 70 is valid for 10 minutes from this unlocking. In addition, the box image 612 corresponding to the unlocked locker box 11 is displayed in a different color from the other box images 612, and a mark 612a indicating that the locker box 11 has been unlocked is added thereto.

The user grasps the position of the unlocked locker box 11 by referring to the unlocking notification screen 610, takes out the commodity from the locker box 11, and closes the door 111 of the locker box 11. Accordingly, the door 111 of the locker box 11 is locked by the lock mechanism 118. As a result, the process of taking out the commodity is completed. Accordingly, as described above, the date and time of takeout is registered in the cell of “takeout date and time” for the box number corresponding to the locker box 11 in the box management information shown in FIG. 6C and FIG. 7.

If, by any chance, the user opens the door 111 of the unlocked locker box 11 but closes the door 111 without taking out the commodity in the locker box 11, the user can unlock the locker box 11 by causing the reader 13 to read the code FIG. 71 of the purchase ticket 70 within 10 minutes from that time. Accordingly, the user can assuredly take out the desired commodity from the locker box 11.

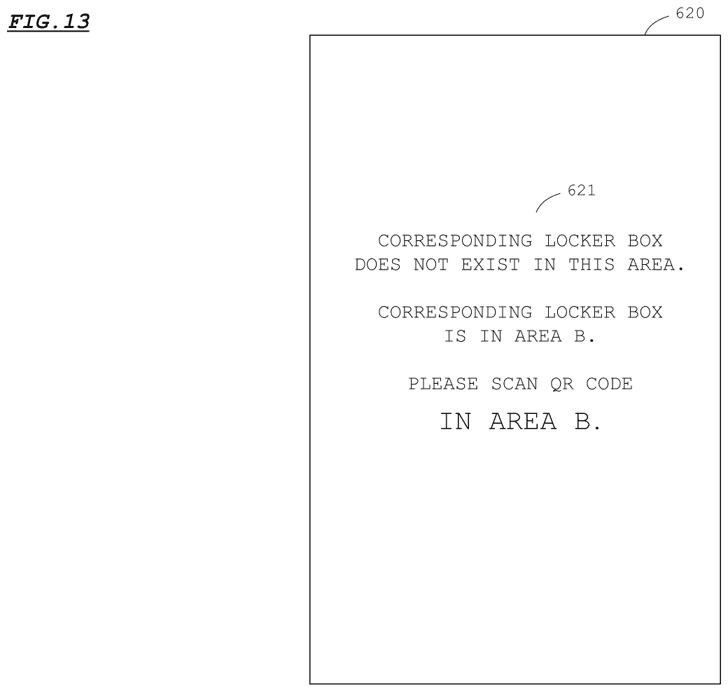

If the box number in the unlocking information read from the purchase ticket 70 does not match any of the locker numbers of the 42 locker boxes 11 of the locker device 10 (consecutive numbers for the four locker devices 10), the controller 301 displays an error notification screen 620 in FIG. 13 on the display input module 12.

The error notification screen 620 includes a message 621 that notifies that the locker box 11 corresponding to the box number in the unlocking information read from the purchase ticket 70 does not exist. Furthermore, the message 621 includes a message that notifies the user of the area where the corresponding locker box 11 exists, and a message that urges the user to cause the code FIG. 71 of the purchase ticket 70 to be read in that area. Accordingly, the user can smoothly take out the commodity from the locker device 10 in the appropriate area.

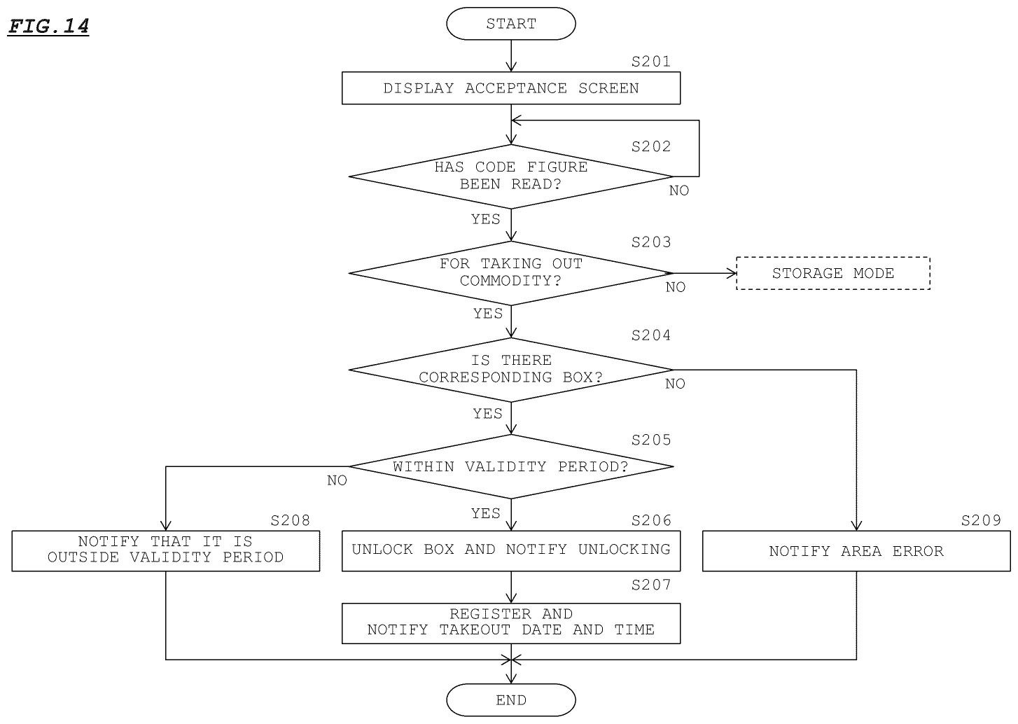

FIG. 14 is a flowchart showing processing of the locker device 10 when a commodity is to be taken out.

The controller 301 of the locker device 10 displays the acceptance screen 600 in FIG. 12A on the display input module 12, thereby urging reading of the purchase ticket 70 (code FIG. 71) (S201). When the user holds the code FIG. 71 over the reader 13, the controller 301 acquires the reading result of the code FIG. 71 from the reader 13 (S202: YES). The controller 301 determines whether or not the reading result is unlocking information for taking out a commodity (S203). Specifically, the controller 301 determines whether or not the reading result conforms to the format in FIG. 11B.

If the reading result is not unlocking information for taking out a commodity (S203: NO), the controller 301 executes the replenishment mode described later. On the other hand, if the reading result is unlocking information for taking out a commodity (S203: YES), the controller 301 refers to the box number in the unlocking information and determines whether or not the box number matches any of the box numbers assigned to the 42 locker boxes 11 of the corresponding locker device 10 (consecutive box numbers for the four locker devices 10) (S204).

If the result of the determination in step S204 is NO, the controller 301 displays the error notification screen 620 in FIG. 13 on the display input module 12 (S209) and ends the processing. In the case where the locker device 10 includes a speaker, the controller 301 may output a message sound that is the same as the message 621 in the error notification screen 620, from the speaker in step S209.

The controller 301 determines NO in step S204 if the store code in the unlocking information does not match the store code of the locker device 10, that is, the store code set for the locker device 10 by the manager of the store as a store code for the store where the locker device 10 is installed. In addition, the controller 301 determines NO in step S204 if the difference between the ticket issuance date and time in the unlocking information and the current date and time does not satisfy a predetermined condition (e.g., the date in the ticket issuance date and time and the date in the current date and time are the same). In each of these cases, the controller 301 displays an error notification screen indicating the reason for the error, on the display input module 12. The above condition may be settable as desired by the manager of the store.

If the result of the determination in step S204 is YES, the controller 301 refers to the box management information in FIG. 7 and determines whether or not the current reading of the unlocking information is within a validity period (10 minutes from the date and time in the cell of “takeout date and time”). If the result of the determination in step S205 is NO, the controller 301 displays a notification screen that notifies that the purchase ticket 70 has expired, on the display input module 12 (S208). In the case where the locker device 10 includes a speaker, the controller 301 may cause the speaker to output a sound message having the same content.

If the result of the determination in step S205 is YES, the controller 301 displays the unlocking notification screen 610 in FIG. 12B on the display input module 12 and unlocks the corresponding locker box 11 (S206). At the same time, the controller 301 lights up the lighting part 117 and the illumination part 119 of the unlocked locker box 11.

Then, the controller 301 registers the current date and time in the cell of “takeout date and time” associated with the box number for the current takeout in the box management information in FIG. 7 and further transmits a notification indicating the commodity has been taken out for the box number, to the ticket issuing device 20 together with the area code of the locker device 10 (S207). Accordingly, the “takeout date and time” corresponding to the locker box 11 in the box management information on the ticket issuing device 20 side is updated. Thus, the controller 301 ends the processing in FIG. 14.

### <Replenishment Mode>

If a locker box 11 in the locker device 10 becomes empty, the manager of the store stores a new commodity in the locker box 11 (replenishes the locker box 11 with a new commodity). In addition, even when there are no empty locker boxes 11, the manager of the store exchanges unsold commodities at regular intervals.

In these cases, in the present embodiment, the manager of the store acquires a password from the server device 30, which manages the commodity sales system 1, using the mobile terminal 40 possessed by the manager. An application program for performing communication with the server device 30 is installed in the mobile terminal 40.

The acquired password is displayed on the mobile terminal 40 in the form of a code figure (QR code: registered trademark) that can be read by the reader 13 of each locker device 10. The format of information held in this code figure is different from the format in FIG. 11B, and the password and the issuance date and time thereof are mainly held in the code figure. The validity period of the password is, for example, 5 minutes. The manager causes the reader 13 of the locker device 10 to be replenished to read the code figure on the mobile terminal 40 within this validity period and performs replenishment with a new commodity.

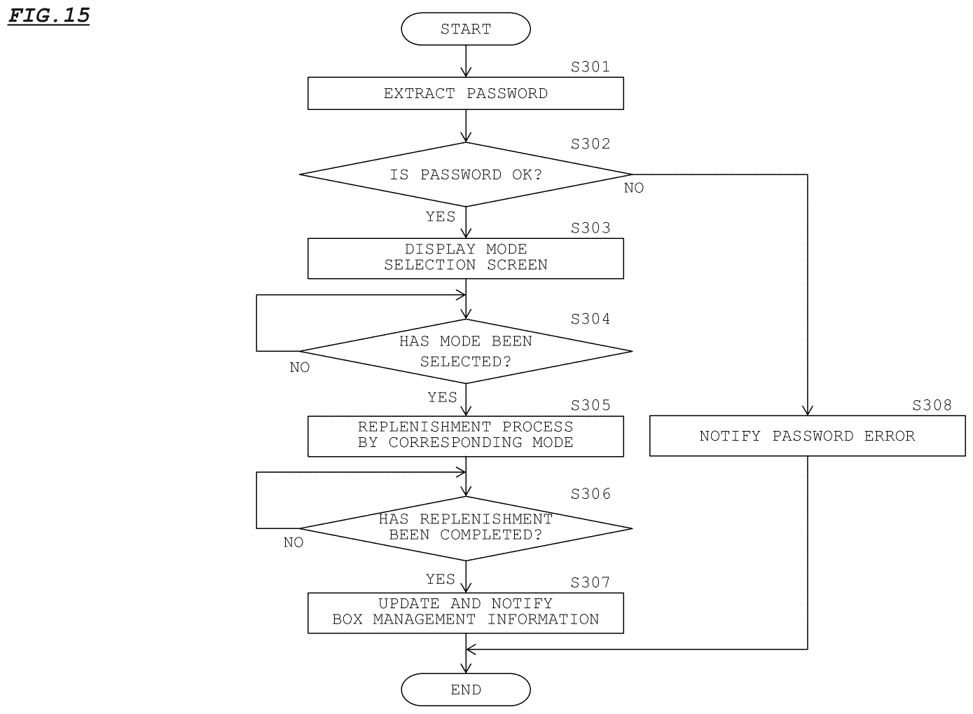

FIG. 15 is a flowchart showing processing performed by the locker device 10 when a locker box 11 is to be replenished with a commodity.

If the result of step S203 in FIG. 14 is NO, the controller 301 of the locker device 10 extracts the password from the information acquired from the code figure in step S202 (S301) and determines whether or not the password is correct (S302).

Here, if the password fails to be extracted from the information, the controller 301 determines NO in step S302. If the password is successfully extracted from the information, the controller 301 makes an inquiry to the server device 30 as to whether or not this password is correct.

The server device 30 checks whether or not the password in question was issued within a most recent predetermined time (e.g., within 5 minutes which is the validity period of the password) by referring to a password issuance history held (stored) by the server device 30 and transmits the check result to the locker device 10 that has made an inquiry. If the received check result indicates that the password was issued within the most recent predetermined time, the controller 301 determines YES in step S302, and in other cases, the controller 301 determines NO in step S302.

If the result of the determination in step S302 is NO, the controller 301 displays a notification screen that notifies that the password of the code figure is not correct, on the display input module 12 (S308). In the case where the locker device 10 includes a speaker, the controller 301 may further output a message sound that notifies this, from the speaker.

If the result of the determination in step S302 is YES, the controller 301 displays a screen for selecting a mode of commodity replenishment on the display input module 12 and accepts a mode selection from the manager (S303). Accordingly, if the manager selects a predetermined mode (S304: YES), the controller 301 executes processing for commodity replenishment by the selected mode (S305).

When, in accordance with this processing, the manager performs commodity replenishment with respect to the locker device 10 and performs a predetermined completion operation (S306: YES), the controller 301 updates the box management information for the locker box 11 replenished with commodities and transmits a notification indicating this update to the ticket issuing device 20 together with the area code (S307). In response to this notification, the box management information on the ticket issuing device 20 side for the locker box 11 is updated. Thus, the controller 301 ends the processing in FIG. 15.

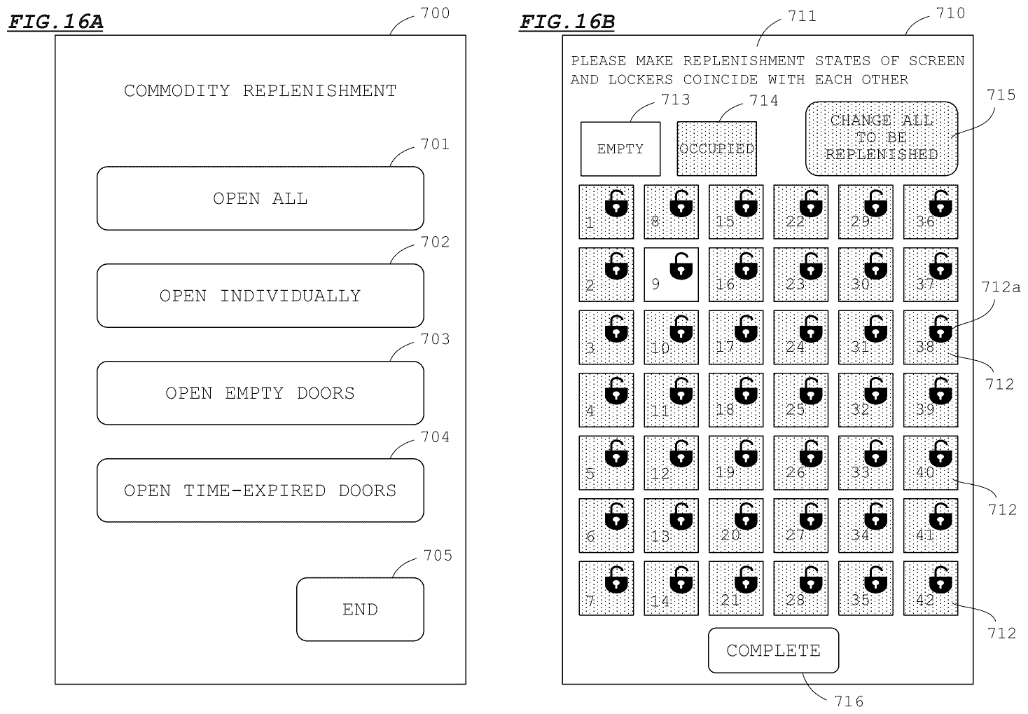

FIG. 16A is a diagram showing a configuration of a mode selection screen 700 displayed in step S303 in FIG. 15.

The mode selection screen 700 includes four mode selection buttons 701 to 704 and a button 705 for terminating the replenishment process without selecting a mode.

A mode in which the doors 111 of all the locker boxes 11 are unlocked (full open mode) is assigned to the mode selection button 701. A mode in which the door 111 of the locker box 11 desired by the manager is individually unlocked (individual open mode) is assigned to the mode selection button 702. A mode in which the door 111 of the empty locker box 11 is unlocked (empty open mode) is assigned to the mode selection button 703. A mode in which the door 111 of the locker box 11 in which the commodity has been stored for a time longer than a certain period (time-expired open mode) is assigned to the mode selection button 704.

FIG. 16B is a diagram showing a configuration of a replenishment acceptance screen 710 displayed in step S305 in FIG. 15 when the mode selection button 701 (full open mode) is selected on the mode selection screen 700 in FIG. 16A.

The replenishment acceptance screen 710 includes a message 711, 42 box images 712, explanation images 713 and 714, a collective change button 715, and a completion button 716.

The message 711 has a content that alerts the manager to make the commodity replenishment state of each locker box 11 on the replenishment acceptance screen 710 coincide with the actual commodity replenishment state of each locker box 11.

The 42 box images 712 are associated with the 42 locker boxes 11, respectively, and are labeled with the box numbers thereof and images 712a indicating an unlocked state.

The explanation images 713 and 714 are images that explain the colors added to the box images 712. If no commodity is stored in the locker box 11 corresponding to a box image 712, the color of the explanation image 713 is added to this box image 712. If a commodity is stored in the locker box 11 corresponding to a box image 712, the color of the explanation image 714 is added to this box image 712. When the display of the replenishment acceptance screen 710 starts, whether or not a commodity is stored in each locker box 11 is determined based on the “sold” item in the box management information in FIG. 7.

The collective change button 715 is operated by the manager when the manager collectively sets all the locker boxes 11 to a state of being replenished with a commodity. The completion button 716 is operated by the manager in response to completion of commodity replenishment.

Since the full open mode is selected here, all the 42 locker boxes 11 are unlocked. Therefore, an image 712a indicating an unlocked state is added to all the 42 box images 712. Here, only the locker box 11 of a box number “9” is empty due to commodity purchase. Each time the manager operates a box image 712, the manager can cyclically change the state of the locker box 11 corresponding to this box image 712 between presence of a commodity and absence of a commodity.

The manager opens the door 111 of each locker box 11 and replenishes the locker box 11 with a new commodity. When the manager replenishes a locker box 11 with a new commodity, the manager operates the box image 712 corresponding to this locker box 11 as appropriate to set this locker box 11 to a commodity-replenished state. This setting may be performed by the manager operating the collective change button 715 after replenishing of all the locker boxes 11 with new commodities is completed.

After performing the operation of replenishing all the locker boxes 11 with new commodities as described above, the manager operates the completion button 716. Accordingly, the result of the determination in step S306 in FIG. 15 becomes YES.

In this case, in step S307, the box management information in FIG. 7 is updated for all the locker boxes 11 replenished with new commodities (the locker boxes 11 for which the box image 712 is set to a commodity-stored state). That is, for these locker boxes 11, the current date and time is registered in the “storage date and time” item, the cell of “takeout date and time” is blanked, and information of “NO” is registered in the “sold” item.

For all the locker boxes 11 replenished with new commodities, a notification indicating that replenishment with a commodity has been performed is transmitted to the ticket issuing device 20 together with the area code. Accordingly, in the box management information in FIG. 6C, the information of the box numbers corresponding to all the locker boxes 11 replenished with new commodities is similarly updated.

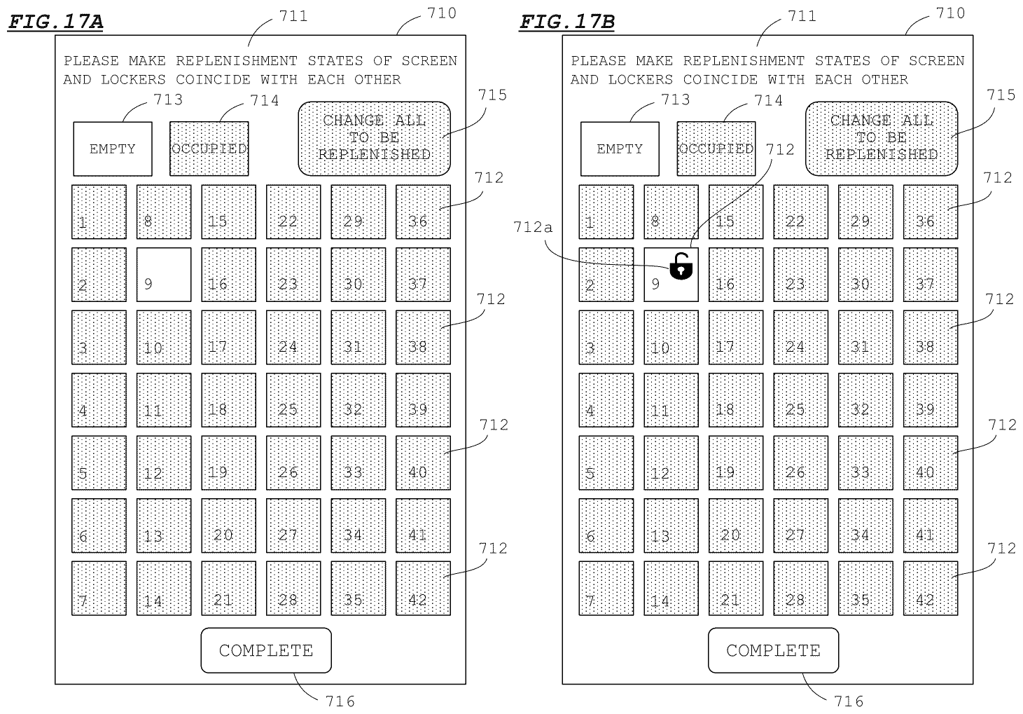

FIG. 17A is a diagram showing a configuration of the replenishment acceptance screen 710 displayed in step S305 in FIG. 15 when the mode selection button 702 (individual open mode) is selected on the mode selection screen 700 in FIG. 16A.

The configuration of the replenishment acceptance screen 710 is the same as in FIG. 16B. However, since the individual open mode is selected here, none of the 42 locker boxes 11 are unlocked. Therefore, an image 712a indicating an unlocked state is not added to any of the 42 box images 712.

In this case, the manager operates the box image 712 corresponding to the locker box 11 that the manager desires to unlock for replenishment with a new commodity. Accordingly, the locker box 11 is unlocked, and an image 712a indicating an unlocked state is added to the corresponding box image 712.

The manager replenishes the unlocked locker box 11 with a new commodity. Furthermore, the manager operates the box image 712 corresponding to the locker box 11 to set the locker box 11 to a replenished state (commodity-stored state). The setting of the replenished state may be performed by operating the collective change button 715. Then, the manager operates the completion button 716. Accordingly, the result of the determination in step S306 in FIG. 15 becomes YES, and the process in step S307 is executed.

Here, after the manager operates the box image 712 for unlocking, the box management information in FIG. 7 is updated only for the locker box 11 for which the box image 712 is set to the replenished state. In addition, a notification of this is transmitted to the ticket issuing device 20 together with the area code, and the box management information in FIG. 6C is updated. In the box management information in FIG. 6C as well, the “storage date and time”, “takeout date and time”, and “sold” items are updated only for the same locker box 11.

FIG. 17B is a diagram showing a configuration of the replenishment acceptance screen 710 displayed in step S305 in FIG. 15 when the mode selection button 703 (empty open mode) is selected on the mode selection screen 700 in FIG. 16A.

The configuration of the replenishment acceptance screen 710 in this case is the same as in FIG. 16B. However, since the empty open mode is selected here, only the locker box 11 that is empty among the 42 locker boxes 11 is unlocked. Therefore, an image 712a indicating an unlocked state is added to the box image 712 corresponding to the empty locker box 11 among the 42 box images 712.

In this case, the manager replenishes the unlocked empty locker box 11 with a new commodity. Furthermore, the manager operates the box image 712 corresponding to the locker box 11 to set the locker box 11 to a replenished state. The setting of the replenished state may be performed by operating the collective change button 715. Then, the manager operates the completion button 716. Accordingly, the result of the determination in step S306 in FIG. 15 becomes YES, and the process in step S307 is executed.

Here, the box management information in FIG. 7 is updated only for the locker box 11 that is set to the replenished state by the manager operating the box image 712 after being unlocked due to being empty. In addition, a notification of this is transmitted to the ticket issuing device 20 together with the area code, and the box management information in FIG. 6C is updated. In the box management information in FIG. 6C as well, the “storage date and time”, “takeout date and time”, and “sold” items are updated only for the same locker box 11.

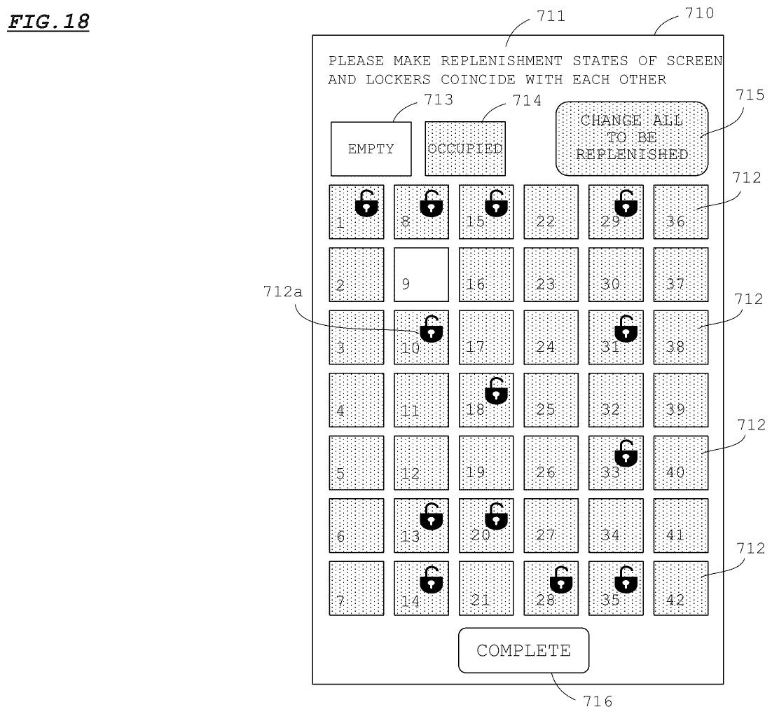

FIG. 18 is a diagram showing a configuration of the replenishment acceptance screen 710 displayed in step S305 in FIG. 15 when the mode selection button 704 (time-expired open mode) is selected on the mode selection screen 700 in FIG. 16A.

The configuration of the replenishment acceptance screen 710 in this case is the same as in FIG. 16B. However, since the time-expired open mode is selected here, only the locker boxes 11 in each of which a commodity has been stored for a time longer than a certain period among the 42 locker boxes 11 are unlocked. Therefore, an image 712a indicating an unlocked state is added to the box images 712 corresponding to these locker boxes 11 among the 42 box images 712.

In this case, the manager replenishes the unlocked time-expiration locker boxes 11 with new commodities. Furthermore, the manager operates the box image 712 corresponding to each of the locker boxes 11 to set the locker box 11 to a replenished state. The setting of the replenished state may be performed by operating the collective change button 715. Then, the manager operates the completion button 716. Accordingly, the unlocked locker boxes 11 are locked, and the process in step S307 in FIG. 15 is executed.

Here, the box management information in FIG. 7 is updated only for the locker boxes 11 that are set to the replenished state by the manager operating the box images 712 after being unlocked due to the time-expiration. In addition, a notification of this is transmitted to the ticket issuing device 20 together with the area code, and the box management information in FIG. 6C is updated. In the box management information in FIG. 6C as well, the “storage date and time”, “takeout date and time”, and “sold” items are updated only for the same locker boxes 11.

### Effects of Embodiment

As shown in FIG. 1 to FIG. 5, the commodity sales system 1 includes the locker device 10 in which commodities are stored in the plurality of locker boxes 11, respectively, the ticket issuing device 20 having a function of settling the purchase prices of commodities, and the controllers 301 and 401. The ticket issuing device 20 includes the ticket issuer 404 and the interface 21 that accepts an input from the user, and the locker device 10 includes the locked part 113 and the lock mechanism 118 (locking unit) provided for each locker box 11, and the reader 13 that reads information. As shown in FIGS. 8A and 8B and FIG. 10, the controller 401 accepts designation of a commodity to be purchased, via the interface 21 (S101 to S104), and causes the ticket issuer 404 to issue the purchase ticket 70 holding the unlocking information for unlocking the locker box 11 in which the designated commodity is stored, in a form that can be read by the reader 13. The controller 301 unlocks the locker box 11 based on the unlocking information read from the purchase ticket 70 by the reader 13.

With this configuration, when purchasing a plurality of commodities at once, the user can acquire the purchase ticket 70 for unlocking each of a plurality of locker boxes 11 in which these commodities are stored, from the ticket issuing device 20, can unlock these locker boxes 11 by causing the reader 13 of the locker device 10 to read the acquired purchase ticket 70, and can take out the commodities therefrom. Therefore, even when purchasing a plurality of commodities at once, the operation for purchasing the commodities can be smoothly and reliably performed.

As shown in FIG. 8B, the controller 401 accepts designation of the locker box 11 in which the commodity to be purchased is stored, as designation of a commodity, and causes the purchase ticket 70 to be issued so as to include the box number (specifying information) specifying the designated locker box 11 in the unlocking information in FIG. 11B. As shown in FIG. 14, the controller 301 unlocks the locker box 11 corresponding to the box number (specifying information) in the unlocking information read by the reader 13 (S204, S206).

With this configuration, the user can take out the commodity designated by the user from the corresponding locker box 11. Therefore, the commodity itself individually desired by the user can be provided to the user.

As shown in FIG. 1 and FIG. 5, the commodity sales system 1 includes the plurality of locker devices 10, and each locker device 10 includes the display input module 12 (notifier). As shown in FIG. 13 and FIG. 14, if the locker box 11 corresponding to the unlocking information read by the reader 13 of the locker device 10 does not exist in this locker device 10 (S204: NO), the controller 301 of this locker device 10 causes the display input module 12 (notifier) to output a notification of this fact (S209).

With this configuration, if the user accidentally causes a locker device 10 that is not the intended one to read the purchase ticket 70, this fact can be notified to the user. Therefore, the user can smoothly advance commodity takeout.

As shown in FIG. 13, in the notification in step S209 in FIG. 14, the controller 301 causes the display input module 12 (notifier) to notify the locker device 10 (area) including the locker box 11 corresponding to the unlocking information read by the reader 13.

With this configuration, the user can grasp which locker device 10 to go to in order to take out the commodity to be purchased. Therefore, the user can smoothly advance commodity takeout.

As shown in FIGS. 8A and 8B and FIG. 11B, the controller 401 accepts designation of the locker device 10 and the locker box 11 in which the commodity to be purchased is stored, as designation of a commodity, and causes the purchase ticket 70 to be issued so as to include the box number (specifying information) that specifies the designated locker box 11 in the designated locker device 10 and is a consecutive number for the four locker devices 10, in the unlocking information. As shown in FIG. 14, if the box number (specifying information) in the unlocking information read by the reader 13 matches any locker box 11 of the locker device 10 that has performed this reading (S204: YES), the controller 301 unlocks the matched locker box 11.

With this configuration, in the case where a plurality of locker devices 10 are installed, the user can smoothly take out the commodity designated by the user from the locker box 11 of the corresponding locker device 10. Therefore, the commodity itself individually desired by the user can be reliably provided to the user.

As shown in FIG. 14, within a certain period (within the validity period) from a predetermined timing (takeout date and time) in the process of taking out the commodity in response to the first unlocking using the purchase ticket, the controller 301 accepts re-unlocking of the locker box 11 using the same purchase ticket 70 (S205).

With this configuration, if the user accidentally closes the door 111 of the locker box 11 without taking out the commodity, the user can unlock the locker box 11 again using the same purchase ticket 70 within the certain period (within the validity period). Therefore, the commodity to be purchased can be reliably provided to the user.

It is also possible to deal with the human error by the user as described above, by control in which the door 111 of the locker box 11 is not locked within a certain period after being unlocked using the purchase ticket 70. However, with this control, the user can open the door 111 of the locker box 11 within the certain period even after properly taking out the commodity. Therefore, there is a risk that an unwanted commodity will be stored in this locker box 11 during this period. For this reason, it is preferable that the door 111 is locked in response to the door 111 being closed after being unlocked. With the above configuration, the above effect is exhibited when this control is performed.

As shown in FIG. 15, based on the reader 13 reading password information (other unlocking information) for commodity replenishment with respect to the locker box 11 (S302: YES), the controller 301 executes the replenishment mode for commodity replenishment (S303 to S306).

With this configuration, the same reader 13 can be further used for a commodity replenishment process. In addition, the manager can smoothly advance commodity replenishment with respect to the locker box 11 by causing the reader 13 of the locker device 10 to be replenished to read the password information (other unlocking information).

As shown in FIG. 16A, the replenishment mode includes the empty open mode (mode selection button 703) for unlocking the locker box 11 from which the commodity has been sold.

With this configuration, the manager can smoothly replenish the empty locker box 11 from which the commodity has been sold, with a commodity.

As shown in FIG. 16A, the replenishment mode includes the time-expired open mode (mode selection button 704) for unlocking the locker box 11 from which the commodity has not been sold and that satisfies a predetermined commodity replacement condition (time-expiration).

With this configuration, the locker box 11 that requires commodity replacement can be smoothly replenished with a new commodity.

Here, the commodity replacement condition is that a period during which the commodity is continuously stored in the locker box 11 exceeds a predetermined threshold value.

With this configuration, the commodity whose quality has decreased due to being stored in the locker box 11 for a long time can be smoothly replaced with a new commodity.

As shown in FIG. 5, the commodity sales system 1 further includes a system (server device 30, mobile terminal 40) that issues password information (other unlocking information) for commodity replenishment.

With this configuration, the manager can acquire the password information (other unlocking information) by the other system.

In the case where food is stored in each locker box 11 as described above, it is preferable that the heat generated by the ticket issuing device 20 does not reach the food in each locker box 11 as much as possible from the viewpoint of maintaining the quality of the food. In addition, it is also preferable that the heat generated in each locker box 11 does not reach the ticket issuing device 20 as much as possible in order to suppress the influence on the operation (coin handling, printing, etc.) of the ticket issuing device 20. In contrast, in the above embodiment, the locker device 10 and the ticket issuing device 20 are installed separately, so that the heat generated in one device is less likely to propagate to the other device. Therefore, both devices can be operated properly and stably.

### <Modification>

In the above embodiment, the code figure including the password for commodity replenishment is provided from the server device 30 to the mobile terminal 40, but this code figure may be issued by the ticket issuing device 20.

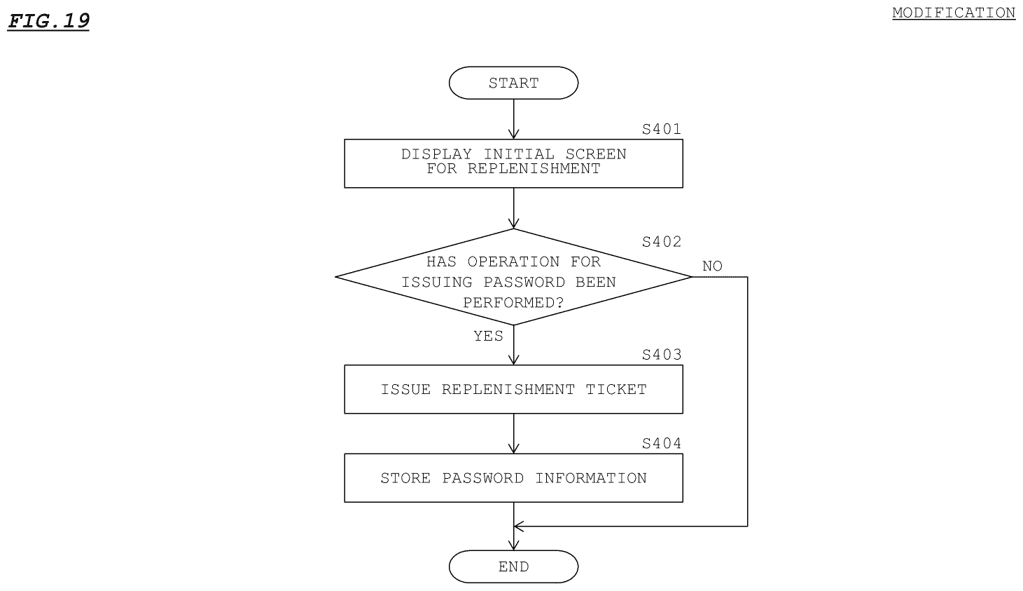

FIG. 19 is a flowchart showing processing of issuing a password for commodity replenishment according to a modification.

The manager performs an operation for displaying a screen for issuing a password, via the interface 21. At this time, the manager inputs a manager ID and an own password to the ticket issuing device 20. Accordingly, the controller 401 of the ticket issuing device 20 displays an acceptance screen for issuing a password on the interface 21 (S401).

When the manager performs an operation for issuing a password for the locker device 10 in the desired area on the acceptance screen (S402: YES), the controller 401 causes the ticket issuer 404 to issue a replenishment ticket for performing commodity replenishment with respect to the locker device 10 in this area (S403). On the replenishment ticket, a code figure holding the area, the password, and the current date and time as password information is printed. The controller 401 stores this password information in the memory 402 (S404).

The manager causes the reader 13 of the corresponding locker device 10 to read the code figure on the issued replenishment ticket. Through the processes from steps S201 to S203 in FIG. 14 to steps S301 and S302 in FIG. 15, the controller 301 of the locker device 10 extracts the password information from the code figure and determines whether or not the password information is correct. In step S302, the controller 301 determines whether or not the area code in the password information matches the area code of the locker device 10 including this controller 301. If these area codes do not match, the controller 301 determines NO in step S302. If these area codes match, the controller 301 makes an inquiry to the ticket issuing device 20 as to whether or not the password in the password information is correct.

The checking process in the ticket issuing device 20 is the same as the checking process in the server device 30. If the password is not correct, the controller 301 executes the same process as in step S308 and ends the processing. If the password is correct, the controller 301 executes the processes in step S303 and the subsequent steps.

With this configuration, commodity replenishment can be performed for the locker device 10 desired by the manager, without using the password issuance system including the server device 30 and the mobile terminal 40. Therefore, the operation of the commodity sales system 1 can be made more convenient.

### <Other Modifications>

In the above embodiment, as shown in FIG. 11B, the box number of the locker box to be unlocked is held in the code FIG. 71 of the purchase ticket 70, but the unlocking information held in the code FIG. 71 is not limited to this.

For example, in the case where a screen for selecting a commodity name or a commodity type is displayed instead of the box selection screen 510 in FIG. 8B when a commodity is to be purchased, the unlocking information held in the code FIG. 71 may include a commodity name or a commodity type instead of the box number. In this case, the controller 301 of the locker device 10 may unlock any locker box 11 in which the commodity is stored, among the locker boxes 11 corresponding to the commodity name or the commodity type read from the code FIG. 71.

In addition, instead of the box number in FIG. 11B (the box number that is a consecutive number for the plurality of locker devices 10), the unlocking information may include information specifying a locker device 10 (e.g., an area code) and the number of a locker box 11 (any of 1 to 42) in the locker device 10. In this case, in step S204 in FIG. 14, the controller 301 of the locker device 10 may determine whether or not the locker box 11 to be unlocked exists, based on whether or not the information (e.g., area code) of the locker device 10 read from the purchase ticket 70 matches the locker device 10 including this controller 301.

In the above embodiment, the validity period in step S205 in FIG. 14 is set based on the date and time when the locker box 11 was first unlocked using the same purchase ticket 70, but the reference time (starting point) for the validity period may be any other date and time as long as it is a timing included in the process of taking out the commodity in response to the first unlocking.

For example, in the case where each locker box 11 has a sensor that detects opening and closing of the door 111, the validity period may be set based on the date and time when the door 111 was first opened using the same purchase ticket 70, or the validity period may be set based on the date and time when the door 111 was closed after being first opened. Alternatively, the validity period may be set based on the date and time when the door 111 was closed and locked after this door 111 was first opened. In addition, in the case where each locker box 11 has a sensor for detecting whether or not a commodity is stored therein, the validity period may be set based on the date and time when it was detected that the commodity had been taken out after the door 111 was first opened. In each of these cases, in step S207 in FIG. 14, the reference date and time is registered in the box management information in FIG. 7, and a notification of this is transmitted to the ticket issuing device 20 at the reference date and time.

It is also possible to set the validity period based on the date and time when the purchase ticket 70 was issued at the ticket issuing device 20. However, if the validity period is set as described above, when the user purchases a plurality of commodities at once, the user has to take out these commodities from the locker device 10 within a certain period from the ticket issuance, which is inconvenient for the user. In contrast, if the validity period is set as in the above embodiment, the user does not have to be restricted by the validity period when taking out each commodity. Therefore, it is preferable that the validity period is set based on a timing (date and time) included in the takeout process in which the locker box 11 is initially unlocked using the same purchase ticket 70.

In the above embodiment, the processing from purchase to takeout of a commodity is shared by the controller 401 of the ticket issuing device 20 and the controller 301 of the locker device 10, but the configuration of the controllers is not limited thereto. In the case where the controller 401 of the ticket issuing device 20 also controls each locker device 10, the controller 401 may perform the above processing from purchase to takeout of a commodity. Alternatively, in the case where a control unit that controls the locker device 10 and the ticket issuing device 20 is provided in addition to the locker device 10 and the ticket issuing device 20, the control unit may perform the above processing from purchase to takeout of a commodity. The controller described in the claims may be composed of the controllers 301 and 401 which are placed in the locker device 10 and the ticket issuing device 20, respectively, as in the above embodiment, or may be composed of one controller as described above.

In the above embodiment, when a plurality of commodities are purchased at once and the total monetary amount is settled at the ticket issuing device 20, the purchase ticket 70 is issued for each commodity (each locker box 11). However, the present invention is not limited thereto, and when a plurality of commodities are purchased at once, one purchase ticket 70 common to the plurality of commodities (plurality of locker boxes 11) may be issued.

In this case, unlocking information for unlocking the plurality of locker boxes 11 is held in the code FIG. 71. When the code FIG. 71 is read by the reader 13, the plurality of locker boxes 11 indicated by the unlocking information are unlocked simultaneously, and the lighting parts 117 and the illumination parts 119 of these locker boxes 11 are lit up. In addition, the unlocking of these locker boxes 11 is reflected in the box images 612 and the message image 613 on the unlocking notification screen 610 in FIG. 12B. The user may take out the commodities from the plurality of unlocked locker boxes 11 while checking the lighting of the lighting parts 117 and the illumination parts 119 and the unlocking notification screen 610.

Alternatively, in this case, when the code FIG. 71 is read by the reader 13, the plurality of locker boxes 11 indicated by the unlocking information may be unlocked sequentially, and the lighting part 117 and the illumination part 119 of the unlocked locker box 11 may be lit up. In this case, when the user takes out the commodity from the unlocked locker box 11 and closes the door 111 of the locker box 11, the door 111 of the next locker box 11 is unlocked, and the lighting part 117 and the illumination part 119 of the locker box 11 are lit up. Such operations are performed sequentially for all the locker boxes 11 held in the code FIG. 71.

In the above embodiment, the validity period in step S205 in FIG. 14 is 10 minutes, but the validity period is not limited to 10 minutes. Similarly, the validity period of the password for commodity replenishment is not limited to 5 minutes.

In the above embodiment, as shown in FIG. 16A, the time-expired open mode is set as a replenishment mode in which the locker box 11 from which the commodity has not been sold and that satisfies the predetermined commodity replacement condition is unlocked, but the commodity replacement condition is not limited to time-expiration. For example, in the case where each locker box 11 has a sensor that detects the freshness or degree of deterioration of a commodity, the commodity replacement condition may be that the freshness decreases to become equal to or lower than a threshold value or the degree of deterioration rises to become equal to or higher than a threshold value.

In the above embodiment, as shown in FIG. 2, each locker box 11 is not labeled with a locker number, but each locker box 11 may be labeled with a locker number.

The configuration of each locker device 10 and the configurations of the various screens shown in the above embodiment are merely examples and may be other configurations. Each locker box 11 may have a refrigeration function or a freezing function. In addition, settling of a purchase price at the ticket issuing device 20 is not limited to settling in cash, and the ticket issuing device 20 may have a non-cash payment unit that can handle credit card, electronic money, code payments, etc.

In addition to the above, the embodiment of the present invention can be modified as appropriate within the scope of the claims.

What is claimed is:

1. A commodity sales system comprising:
a locker device in which commodities are stored in a plurality of locker boxes, respectively;
a ticket issuing device having a function of settling purchase prices of the commodities; and
a controller, wherein
the ticket issuing device includes
a ticket issuer, and
an interface configured to accept an input from a user,
the locker device includes
a locking unit provided for each of the locker boxes, and
a reader configured to read information, and
the controller
accepts designation of a commodity to be purchased, via the interface,
causes the ticket issuer to issue a purchase ticket holding unlocking information for unlocking the locker box in which the designated commodity is stored, in a form that can be read by the reader, and
unlocks the locker box based on the unlocking information read from the purchase ticket by the reader.

2. The commodity sales system according to claim 1, wherein
the controller
accepts designation of the locker box in which a commodity to be purchased is stored, as designation of the commodity,
causes the purchase ticket to be issued so as to include specifying information specifying the designated locker box in the unlocking information, and
unlocks the locker box corresponding to the specifying information in the unlocking information read by the reader.

3. The commodity sales system according to claim 1, wherein
a plurality of the locker devices are included,
each of the locker devices includes a notifier, and
if the locker box corresponding to the unlocking information read by the reader of one said locker device does not exist in the one said locker device, the controller causes the notifier to output a notification indicating that this locker box does not exist in the one said locker device.

4. The commodity sales system according to claim 3, wherein the controller causes the notifier to notify the locker device including the locker box corresponding to the unlocking information read by the reader, in the notification.

5. The commodity sales system according to claim 3, wherein
the controller
accepts designation of the locker device and the locker box in which a commodity to be purchased is stored, as designation of the commodity,
causes the purchase ticket to be issued so as to include specifying information specifying the designated locker box in the designated locker device, in the unlocking information, and
if the specifying information in the unlocking information read by the reader matches any of the locker boxes of the locker device that has performed the reading, unlocks the matched locker box.

6. The commodity sales system according to claim 1, wherein the controller accepts re-unlocking of the locker box using the purchase ticket within a certain period from a predetermined timing in a process of taking out the commodity in response to the unlocking.

7. The commodity sales system according to claim 1, wherein the controller executes a replenishment mode for commodity replenishment, based on the reader reading other unlocking information for commodity replenishment with respect to the locker box.

8. The commodity sales system according to claim 7, wherein the replenishment mode includes a mode in which the locker box from which the commodity has been sold is unlocked.

9. The commodity sales system according to claim 7, wherein the replenishment mode includes a mode in which the locker box from which the commodity has not been sold and that satisfies a predetermined commodity replacement condition is unlocked.

10. The commodity sales system according to claim 9, wherein the commodity replacement condition includes a condition that a period during which the commodity is continuously stored in the locker box exceeds a predetermined threshold value.

11. The commodity sales system according to claim 7, further comprising a system configured to issue the other unlocking information.

12. The commodity sales system according to claim 7, wherein the controller causes the ticket issuer to issue a replenishment ticket holding the other unlocking information in a readable form, in response to a predetermined input to the interface.

13. A control method for a commodity sales system including a locker device in which commodities are stored in a plurality of locker boxes, respectively, and a ticket issuing device having a function of settling purchase prices of the commodities, the control method comprising:
accepting designation of a commodity to be purchased, via an interface;
causing the ticket issuing device to issue a purchase ticket holding unlocking information for unlocking the locker box in which the designated commodity is stored, in a readable form; and
unlocking the locker box based on the unlocking information read from the purchase ticket.

14. A ticket issuing device having a function of settling purchase prices of commodities stored in a plurality of locker boxes of a locker device, respectively, the ticket issuing device comprising:
a ticket issuer;
an interface configured to accept an input from a user; and
a controller, wherein
the controller
accepts designation of a commodity to be purchased, via the interface, and
causes the ticket issuer to issue a purchase ticket holding unlocking information for unlocking the locker box in which the designated commodity is stored, in a form that can be read by a reader of the locker device.

15. A locker device constituting a commodity sales system together with a ticket issuing device according to claim 14, the locker device comprising:
a plurality of locker boxes for storing commodities, respectively;
a locking unit provided for each of the locker boxes;
a reader configured to read information; and
a controller configured to unlock the locker box based on the unlocking information read from the purchase ticket by the reader.
